(19) United States
(12) Patent Application Publication
(10) Pub. No.: US 2022/0136738 A1
(43) Pub. Date: May 5, 2022

(54) Top-Surface-Cooled, Directly Irradiated Liquid Receiver For Concentrated Solar Power

(71) Applicant: Khalifa University of Science and Technology, Abu Dhabi (AE)

(72) Inventor: Peter Ross ARMSTRONG, Abu Dhabi (AE)

(21) Appl. No.: 17/433,473

(22) PCT Filed: Feb. 25, 2020
(86) PCT No.: PCT/IB2020/051582

§ 371 Date: Aug. 24, 2021

Related U.S. Application Data
(60) Provisional application No. 62/809,926, filed on Feb. 25, 2019.

(51) Int. Cl. F24S 60/30; F24S 70/60

(52) U.S. Cl. CPC F24S 60/30; F24S 70/60

(57) ABSTRACT

A thermal energy storage (TES) for Concentrated Solar Power (CSP) plants consists of a two-tank molten salt storage. There is a provided need for a thermal energy receiving and storage system for CSP plants. To demonstrate how thermocline TES can be used in the CSPonD concept, a water tank is used for receiving a heat transfer fluid, which includes an absorbing mesh that is mountable within the tank for establishing and maintaining natural stratification resulting in a thermocline zone within the tank, and additionally comprises a plug flow injection system for establishing plug flow within the tank. A method of establishing and maintaining natural stratification, involves pumping cold heat transfer fluid, injecting the cold heat transfer fluid, and controlling the pumping and the injecting, all within the tank.

### FIELD OF THE INVENTION

The present invention relates to the field of mechanical engineering, more particularly to solar thermal power systems that include a thermal receiver and thermal energy storage (TES) system.

### BACKGROUND OF THE INVENTION

Background description includes information that may be useful in understanding the present invention. It is not an admission that any of the information provided herein is prior art or relevant to the presently claimed invention, or that any publication specifically or implicitly referenced is prior art.

Worldwide electrical energy consumption is rising at a fast rate leading to an increased depletion of non-renewable energy sources and serious environmental concerns. For instance, energy consumption in the United Arab Emirates (UAE) reached 1,014,136 GWh in 2011, 35% of which originated from burning oil and the remaining 65% from natural gas.

Therefore, further development and cost reduction of renewable energy production systems become a necessity. In January 2009, UAE established a sustainable energy target of 7% by 2020 for the Abu Dhabi energy plan and also in 2009 a 10 MW solar photovoltaic plant at Masdar city, Abu Dhabi, was completed.

Among all renewable energy sources, solar energy is the most abundant energy resource on earth. An analysis by the International Energy Agency (IEA) shows that solar energy could provide up to one-third of the world's total energy demand after 2060. Thanks to its comparatively high solar resources, UAE has great potential to supply a major part of the country's electricity demand by using solar power.

Currently, the two main electricity production technologies from solar power that are available on the market are photovoltaic (PV) and Concentrating Solar Power (CSP). A major advantage of CSP over PV is its ability to produce electricity on demand and independently of weather conditions if combined with thermal storage, which is not the case for PV. Consequently, to improve competitiveness of CSP plants and further reduce their costs, extensive research efforts are focused on thermal energy storage (TES) systems.

In a CSP plant solar radiation is concentrated by a suitable configuration of mirrors forming the solar field, and is typically collected by a heat transfer fluid (HTF) flowing in a tubular receiver and pumped to a TES tank. Once the heat is collected it can be directly converted into electricity by a conventional thermal power cycle or stored for later conversion to electricity when needed as shown in FIG. 1(a). The figure shows a typical CSP tower plant layout with a two-tank molten salt storage in which the HTF, a binary eutectic of sodium and potassium nitrate salts in molten form, is stored. Such a TES system consists of two insulated tanks, referred to as hot tank and cold tank, which are used to store the hot HTF coming from the TES tank and the cold HTF coming out of the steam generator respectively. Typical hot and cold molten nitrate salts operating temperatures in tower plants are around 565° C. and 280° C.

CSP plants are classified in four types based on the solar field layout; parabolic trough, linear Fresnel, power tower and parabolic dish. In power towers, 2-axis tracking mirrors, called heliostats, are placed on the ground, to concentrate radiation onto a receiver placed on top of a tower as shown in FIG. 1(a). An alternative configuration is a beam-down tower in which central reflectors (CR) are placed on top of the tower to reflect the concentrated rays down towards the ground. By placing the TES tank on the ground, the need for molten salt piping to the top of the tower and strong tower structures to support the piping and receiver are eliminated along with associated costs of pumping and operating heaters to keep the salt molten during morning startup. Up until 2017, only three beam-down tower optical systems, all for research, had been built worldwide. One of them, the 100 kW Beam-down Optical Experiment (BDOE) built in 2009, is shown in FIG. 1(b).

One researcher proposed to use a beam-down CSP to heat a tank of molten nitrate salts (HTF) by direct irradiation from the CR. In their concept the top of the tank has a quartz window and the heated HTF is used to generate steam for a solar power plant. A more recent molten salt TES tank and storage concept—Concentrated Solar Power on Demand (CSPonD), has been proposed by an MIT team and a demonstration of such system is ongoing at the BDOE at MIST. It consists of a single molten salt tank placed at the focal point of a beam down tower which acts both as an open direct-absorption TES tank and a storage tank as shown in FIG. 1(c). Use of a single tank receiver/TES system offers an interesting cost-reduction potential.

The schematic in FIG. 1(d) describes the functioning of CSPonD receiver and TES. A 100 kW^{th} concentrated irradiation enters from the open aperture at the top and gets absorbed volumetrically by the salts within the upper zone (hot salts) separated from the lower zone (cold salts) by an insulated divider plate which acts as a physical and thermal barrier to effectively separate the hot and cold salt zones. Molten salts are continuously extracted from the hot upper zone to deliver 25 kW^{th} through a heat exchanger (used as a steam generator) and flows back to the bottom of the tank where it enters the cold zone. With 8 hours of charge and 16 hours' discharge, the tank has a thermal storage capacity of 400 kW^{th}, while continuously delivering 25 kW of thermal power. The cold salt can enter the hot zone to be heated up through a lateral gap between the divider plate and the tank wall. This flow is controlled by vertical movement of the divider plate.

If the divider plate is not used, natural thermal stratification phenomenon in the salt, resulting from buoyancy forces, would still separate hot salts from cold salts. However, a temperature-gradient zone called thermocline would be present between the two zones and could be relatively large. The divider plate stops the irradiation from reaching the cold zone and keeps it in the hot zone by absorbing it and transferring it to the hot salts or reflecting back a part of it. However, the salts semi-transparent behaviour leads to distributed absorption of solar radiation over the available depth above the divider plate which will result in an undesirable temperature gradient in the hot zone, especially during the end of charging phase when a divider plate is near bottom of the tank which is reached by only a very small fraction of incident radiation. Indeed, a separately controlled mixing plate has been proposed to address this problem.

Use of the divider plate and mixing plate adds some complications to the concept. Main complication is the need of actuators for control of their movements which requires the whole design to be adapted. For instance, it requires stronger cover with a conical shape to support the load of the pulleys and the chains used for the plates' movements, special fitting of the extra elements within the whole system and caution during the design phase to avoid interference between the different parts and a secondary concentrator placed on top of the tank's aperture. Another issue is raised by the remaining salts on the chains after they get out of the tank as they can freeze and possibly disturb the functioning of the pulleys and hoist mechanisms.

### SUMMARY OF THE INVENTION

In an embodiment of the present invention, is disclosed a thermal energy receiving and storage system for concentrated solar power (CSP) plants comprising, a tank for receiving a heat transfer fluid, an absorbing mesh mountable within the tank for establishing and maintaining natural stratification resulting in a thermocline zone within the tank, and a plug flow injection system for establishing plug flow within the tank.

In another embodiment, the tank has a bottom portion having a basis and a top portion having an opening and wherein the absorbing mesh is located at the top portion of the tank in proximity of the opening.

In another embodiment of the present invention, the absorbing mesh is configured for moving the thermocline zone downwardly in direction of the bottom portion of the tank.

In a preferred embodiment of the present invention, the absorbing mesh is a woven wire mesh made of black anodized stainless steel.

In an embodiment of the present invention, the absorbing mesh comprises multiple layers deployed along a vertical axis of the tank between the basis and the opening of the tank.

In an embodiment of the present invention, wherein the number of layers forming the absorbing mesh is between 5 and 15.

In an embodiment of the present invention, the plug flow injection system comprises a pump for pumping cold heat transfer fluid from the bottom portion of the tank into the top portion of the tank above the absorbing mesh.

In an embodiment of the present invention, the plug flow injection system further comprises hoses distributed within the tank, the hoses having openings for directing flow jets of the pumped cold heat transfer fluid across beneath the HTF surface within the tank.

In an embodiment of the present invention, the hoses comprise a cylindrical hose positioned intermediate the tank opening and the absorbing mesh, the cylindrical hose defining a circle having a central axis and having openings for directing flow jets inwardly in the direction of the central axis for the purpose of establishing the plug flow in which the temperature distribution is essentially one-dimensional in the vertical direction with the coldest HTF residing at top and bottom of tank (FIGURE).

In an embodiment of the present invention, the tank has a vertical axis between the bottom portion and the top portion and horizontal cross-sections extending perpendicular to the vertical axis between the bottom basis and the opening, and wherein the heat transfer fluid has a temperature uniform across each horizontal cross-section once the plug flow is established.

In an embodiment of the present invention, the stratification and the plug flow assist in moving the thermocline zone from the top portion of the tank in proximity of the opening to the bottom portion of the tank in proximity of the basis during charging.

In an embodiment of the present invention, the thermal energy receiving and storage system is free of any divider plate.

In an embodiment of the present invention, the natural stratification resulting in the thermocline zone is achieved without using any divider plate.

In an embodiment of the present invention, a method of establishing and maintaining natural stratification in the purpose of obtaining a thermocline zone and a plug flow within a CSP tank storing heat transfer fluid between a tank basis at a bottom portion of the tank and a tank opening at a top portion of the tank, the method comprising, providing an absorbing mesh within the tank in proximity of the opening, pumping cold heat transfer fluid from the bottom portion of the tank into the top portion of the tank above the absorbing mesh, injecting the cold heat transfer fluid to form inward flowing jets just below or upon the molten salt surface, and controlling the pumping and the injecting for establishing and maintaining the natural stratification, the thermocline zone and the plug flow within the CSP tank.

In an embodiment of the present invention, the absorbing mesh is configured for moving the thermocline zone downwardly in direction of the bottom portion of the tank while charging.

In an embodiment of the present invention, the absorbing mesh is a woven wire mesh made of black stainless steel.

In an embodiment of the present invention, the absorbing mesh comprises multiple layers deployed along a vertical axis of the tank between the basis and the opening of the tank.

In an embodiment of the present invention, the various defined areas to which the flow jets are directed comprise a circular area having a central vertical axis intermediate the tank opening the absorbing mesh, wherein the flow jets are directed inwardly in the direction of the central axis in the purpose of establishing plug flow and a stable inverted temperature profile within the mesh region.

In an embodiment of the present invention, the CSP tank has a vertical axis between the bottom portion and the top portion and horizontal cross-sections extending perpendicular to the vertical axis between the bottom basis and the opening, and wherein the heat transfer fluid has a temperature uniform across each horizontal cross-section once the plug flow is established.

In an embodiment of the present invention, the stratification and the plug flow assist in moving the thermocline zone from the top portion of the tank in proximity of the opening to the bottom portion of the tank in proximity of the basis while charging.

In an embodiment of the present invention, the natural stratification resulting in the thermocline zone is achieved without using any divider plate.

### BRIEF DESCRIPTION OF THE DRAWINGS

The subject matter that is regarded as the invention is particularly pointed out and distinctly claimed in the claims at the conclusion of the specification. The following drawings form part of the present specification and are included to further demonstrate certain aspects of the present invention, the inventions of which can be better understood by reference to one or more of these drawings in combination with the detailed description of specific embodiments presented herein. The foregoing and other aspects, features, and advantages of the invention are apparent from the following detailed description taken in conjunction with the accompanying drawings in which:

FIG. 1(a) illustrates the CSP tower plant with two-tank molten salt storage (Prior Art)

FIG. 1(b) illustrates the Beam-Down Optical Experiment (BDOE) at Masdar Institute (Prior Art)

FIG. 1(c) illustrates schematically a CSPonD tank integrated with the BDOE (Prior Art)

FIG. 1(d) illustrates schematically the functioning of a CSPonD receiver and TES (Prior Art)

FIG. 1(e) illustrates schematically the alternative single tank mesh-absorber or thermocline-storage concept while charging in accordance with one aspect of the invention

FIG. 2(a) illustrates the thermocline zone, FIG. 2(b) illustrates two semi-infinite solids at t=t0, FIG. 2(c) illustrates two semi-infinite solids at t=t1, FIG. 2(d) illustrates the thermocline coordinate system, FIG. 2(e) illustrates the thermocline evolution while charging of a molten salt TES using the coupled semi-infinite slabs model, simple initial and boundary conditions, and constant plug flow of 0.15 l/s in a 1.6-m high by 1.3-m diameter tank.

FIG. 2(f) illustrates the thermocline evolution while discharging of the molten salt TES and FIG. 2(g) illustrates thermocline evolution while charging of a water TES.

FIG. 3(a) illustrates a water tank calorimeter without sidewall insulation, FIG. 3(b) illustrates a water tank calorimeter with insulation and FIG. 3(c) illustrates the locations of thermocouples inside the water tank.

FIGS. 3(d) and 3(e) illustrate the thermocouple tree.

FIG. 3(f) illustrates locations of thermocouples taped at the inner wall view from the north, FIG. 3(g) illustrates the temperature distribution within the water tank on Feb. 9, 2015 and FIG. 3 (h) illustrates the ambient and water tank temperatures in response to a measured DNI trajectory.

FIG. 3(i) illustrates the temperature distribution on the wall of water tank, FIG. 3(j) illustrates the temperature distribution on the floor of the water tank, FIG. 3(k) illustrates incident pattern of strongest flux and convective cell promoted by it, FIG. 3(l) illustrates the temperature distribution across top horizontal points and FIG. 3(m) illustrates the temperature distribution along the vertical axis.

FIG. 4(a) illustrates the side view of a small-scale square volume mesh absorber and FIG. 4 (b) illustrates the top view of a small-scale square volume mesh absorber.

FIG. 4(c) illustrates the apparatus for testing absorptance of a mesh volume absorber (halogen lamp) and FIG. 4 (d) illustrates the apparatus for testing absorptance of a mesh volume absorber (pyranometer).

FIG. 4(e) illustrates results of testing optical absorptance of a volume mesh absorber and FIG. 4(f) illustrates simplified depiction of the traverse pattern in mesh assembly reference frame.

FIG. 4(g) illustrates real view of a Large scale volume mesh absorber and FIG. 4(h) illustrates schematic view of a Large scale volume mesh absorber.

FIG. 4(i) illustrates slotted angle structure placed inside the water tank, FIG. 4 (j) illustrates installed volumetric mesh absorber inside the water tank without radiation shield and with a radiation shield.

FIG. 4(k) illustrates temperature distribution inside the mesh volume absorber and FIG. 4(l) illustrates temperature comparison between the mesh and outside the mesh at z=122.5 cm.

FIG. 4(m) illustrates the temperature comparison at upper and lower points of the water tank (Avg_of_TC2,8,14,20 is at z=44.5 cm and Avg_of_TC6,24 is at z=122.5 cm), FIG. 4(n) illustrates the temperature distribution at different levels of the water tank and FIG. 4(o) illustrates the temperature comparison at different heights near the water tank wall (Avg. TC21 is at z=64 cm, Avg. TC22 is at z=83.5 cm)

FIG. 5(a) illustrates the plug Flow injection system, FIGS. 5(b) and 5 (c) illustrate the apparatus for jet characterization and FIG. 5(d) illustrates propagation distance of the pumped water.

FIG. 5(e) illustrates propagation distance of jet, FIG. 5 (f) illustrates Schematic of plug flow injecting system, FIG. 5 (g) illustrates average flow rate of pump with DNI and FIG. 5(h) illustrates average flow rate of pump with a temperature at top layer of mesh.

FIG. 5(i) illustrates the temperature distribution inside the water tank and FIG. 5(j) illustrates comprehensive view of temperature distribution inside the Volumetric Mesh Absorber.

FIG. 5(k) illustrates temperature distribution inside the Volumetric Mesh Absorber at hour of interest: 11:40-12:40, FIG. 5(l) depicts average temperature on TC_5,23 and FIG. 5(m) shows thermocline evolution obtained by experiment with Excel interpolation.

FIG. 5(n) illustrates the water Level Point, FIG. 5(o) illustrates the temperature distribution inside the water tank and FIG. 5(p) illustrates the temperature distribution inside the volume mesh absorber.

### DETAILED DESCRIPTION OF THE INVENTION

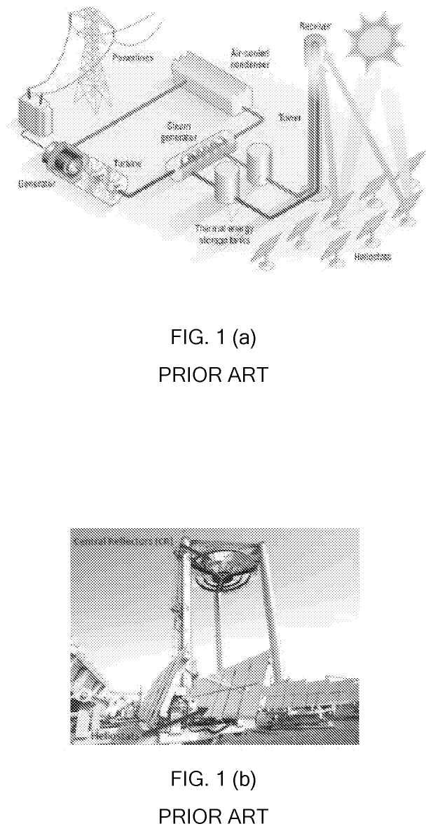

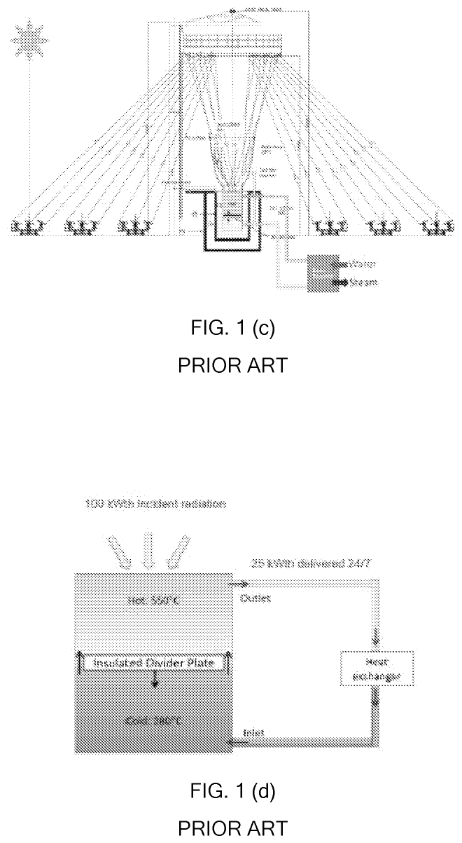

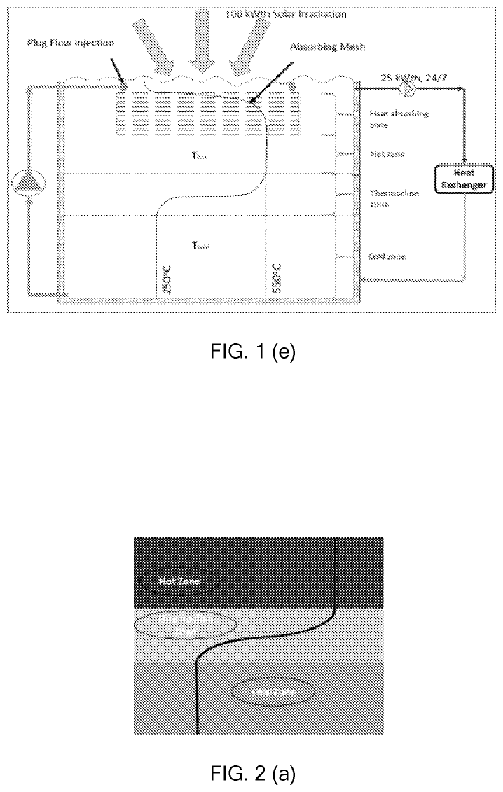

The present work proposes an alternative single tank receiver/storage without the divider plate based on natural stratification and localized absorption using a fixed mesh at the aperture as described in FIG. 1(e). In this case, cold salts are pumped up from the bottom of the tank and introduced on top of a highly absorbing mesh. Incident solar radiation is expected to be absorbed entirely by the mesh and transferred to the salts which are expected to reach the required hot operating temperature by the mesh outlet. Then, natural stratification should occur with separate the hot and cold zones, and a thermocline zone in-between. The plug flow assumption should reduce the natural convection cells which could result in overheating near the top of the mesh. Extraction of the hot salt for use in steam generator is unchanged from the CSPonD concept. The major modification to the CSPonD concept is the replacement of divider plate and its actuator by an absorbing mesh and a salts injection system with an appropriate variable-speed pump.

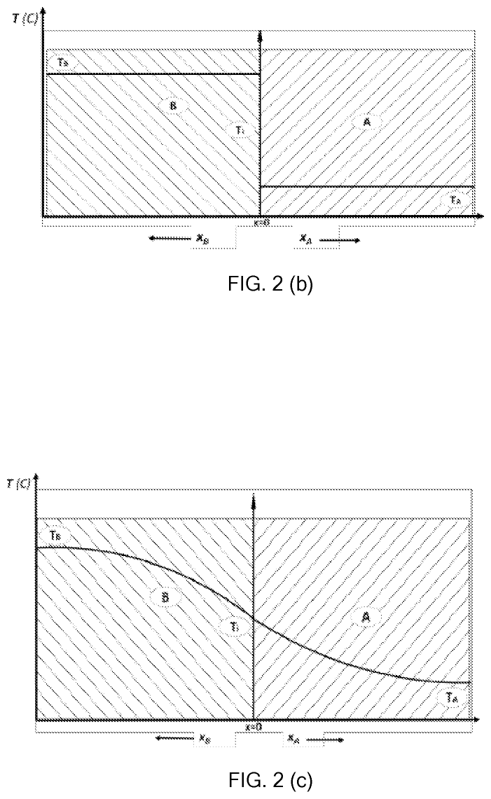

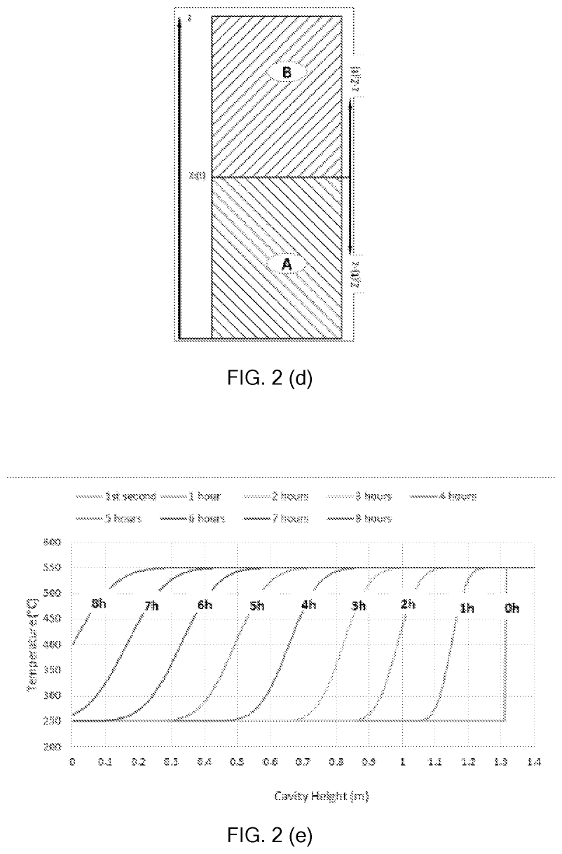

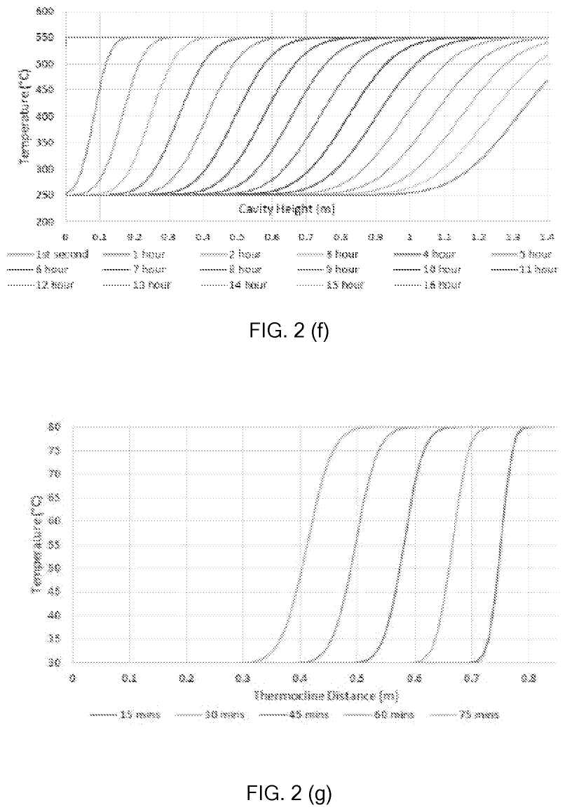

Thermocline (depicted in FIG. 2(a)), or the thermocline zone—a zone of water in which the temperature gradient is very different from the gradients of the above and the underlying zones. Thermocline thickness theoretical calculation is developed using the semi-infinite solid body theory as presented below. Then it is applied to the CSPonD tank using either water as a heat transfer fluid (HTF) to be compared to measured thermocline thickness from the proposed experiment, or molten salt as an HTF to be compared to the thickness of the divider plate in the CSPonD concept.

The installation of a divider plate in the CSPonD concept creates a number of disadvantages. Therefore, it is desirable to know the thickness of the thermocline; because, if the thermocline thickness is equal or slightly thicker than a divider plate, it is not necessary to install a divider plate. As the natural thermocline will be sufficient to keep a separation between the TES tank's hot and cold zones. Accordingly, in order to estimate the thermocline thickness of a molten salt cavity receiver, the assumption of contact between two semi-infinite solid bodies is used. Thus, consider two semi-infinite solid bodies as shown FIG. 2(b). These bodies, A and B, have different uniform temperatures T_{A} and T_{B} and they are put in contact at time t=0.

Because they have different uniform temperatures, there must be heat transfer q between the two bodies and the heat flux into body A that is q_{A} at x=0 must be equal to heat flux out of body B which is q_{B} at x=0. Bodies A and B are assumed to have essentially equal properties of thermal conductivity, density and specific heat capacity, k_{A}≈k_{B}, ρ_{A}≈ρ_{B}, and c_{pA}≈c_{pB}. After some time (at t=t₁) temperature distribution will be similar to FIG. 2(c); furthermore, the interface temperature Ti remains the same. During the heat transfer process, the rate of heat transfer across the interface diminishes with time.

So, heat flux into body A is given by:

$${q}_{A} = \frac{{k}_{A} * ( {T}_{i} - {T}_{A 0} )}{\sqrt{π {α}_{A} t}} \qquad Eq . 1$$

where:
T_{A0}—initial temperature of A body (° C.), T_{B0}—initial temperature of B body (° C.), k—thermal conductivity (W/mk) and α—thermal diffusivity (m²/s)

$$α = \frac{k}{ρ {c}_{p}}$$

For −q_{A}=q_{B} we have:

$$- \frac{{K}_{A} * ( {T}_{I} - {T}_{A 0} )}{{\sqrt{π α}}_{A} t} = \frac{{K}_{B} * ( {T}_{I} - {T}_{A 0} )}{\sqrt{π α} B t} \qquad Eq . 2$$

Solving Eq. 2, for Ti, will give;

$${T}_{i} = \frac{{f}_{A} {t}_{A 0} + {f}_{B} t {B}_{0}}{{f}_{A} + {f}_{B}} \qquad Eq . 3$$

Where: f_{A}=f_{B}=\sqrt{kpC}ₚ Eq. 4

As properties of two bodies are the same in our case, (kA=kB and αA=αB), then:

$${T}_{i} = \frac{{T}_{A 0} * {T}_{B 0}}{2} \qquad Eq . 5$$

Eq. 5 gives the dimensionless temperature distribution in a semi-infinite body if the complementary error function is used:

$$\frac{T - {T}_{0}}{{T}_{i} - {T}_{0}} = erfc \frac{X}{{( 4 α t )}^{0.5}} \qquad Eq . 6$$

where, T₀ is a temperature at time t=0, and refers to T_{A0} or T_{B0} depending on the zone (A or B) corresponding to the value of x. Note that both x and t appears on the RHS of Eq. 6 thus TA is function of x_{A} and t and T_{B} is function of x_{B} and t.

Molten salt thermocline evolution calculations are presented below to compare with the concept of CSPonD. The main objective is to see whether there is any chance to avoid the divider plate by using natural stratification of hot and cold HTF. To carry out the numerical calculations, it is necessary to separate the whole process into two periods: a charging period, which is during the day and discharging period, which happens at night. The geometry of a molten salt cavity receiver is assumed to be equal to the geometry of the water tank which was used for the experiment. Therefore, the followings show the geometry of a molten salt cavity receiver. Height H=1.312 m, Diameter d=1.53 m, and hence the area and the volume is: Surface area is A=1.84 m² and volume is V=2.41 m³

In order to use the model of two semi-infinite solids in contact, the whole TES tank is initially assumed to be at 250° C. and it is exposed to the heat of 550° C. That is, the temperature of the cold zone A is at TA0=250° C. and that of the hot zone B is at TB0=550° C. (FIG. 2(d)). Additionally, plug flow is injected and distributed uniformly from the top of the TES tank by pumping certain amount of HTF from bottom to the top of the TES tank as shown in FIG. 1(f) of two semi-infinite solids in contact, the whole TES tank is initially assumed to be at 250° C. and it is exposed to the heat of 550° C. That is, the temperature of the cold zone A is at TA0=250° C. and that of the hot zone B is at TB0=550° C. (FIG. 2D). Additionally, plug flow is injected and distributed uniformly from the top of the TES tank by pumping certain amount of HTF from bottom to the top of the TES tank as shown in FIG. 1(e).

Thus, using the Eq.5, interface temperature Ti can be found:

$${T}_{i} = \frac{{T}_{A 0} + {T}_{B 0}}{2} = \frac{250 C . + 550 C .}{2} = 400 ° C . \qquad Eq . 7$$

Shown in FIG. 2D, the interface between both zones A and B is referenced by Zi(t). As a plug flow is applied from the top of the tank, the level of the thermocline interface varies through time as follows:

$${Z}_{i} ( t ) = {Z}_{i} ( 0 ) - t * H * \frac{\dot{m}}{M} \qquad Eq . 8$$

### Where:

Zᵢ (0)—thermocline interface height at t=0
\dot{m}—flow rate of HTF pumped from bottom to top of the TES tank (kg/s)
M—mass of HTF in TES tank (kg)
t—time (s)

Next, Eq 6. is applied on both sides of the interface for each of the zones A and B. In zone A, z<Zi and as: T0=TA0, Ti0=400° C., TA0=250° C., thus from Eq. 6 Ti−TA0=150° C. and x=Zi(t)−z, Hence, after simplification, the Eq 6 becomes:

$${T}_{A} ( z , t ) = 250 + 150 * erfc \frac{{Z}_{i} ( t ) - z}{{( 4 α t )}^{0.5}} \qquad Eq . 9$$

In zone B, T0=TB0, Ti=400° C., TB0=550° C., thus from Eq. 6, Ti−T0=−150° C. and X=Z−Zi(t). Hence, after simplification, Eq. 6 becomes:

$${T}_{B} ( z , t ) = 550 - 150 * erfc \frac{z - {Z}_{i} ( t )}{{( 4 α t )}^{0.5}} \qquad Eq . 10$$

where: α=1.80E-07 m/s²
The following values were calculated to evaluate Eq. 8: \dot{m}=0.16 kg/s, H=1.312 m and M=4630 kg.

Similarly, exact calculations can be done for discharging period which is during the night for 16 hours. Hence, during this period, the only change is the time period, mass flow rate and the direction of the plug flow, from bottom to top of the tank. Here, it is assumed that at the TES tank is fully charged at the beginning of the discharge. Temperature distribution results are plotted in FIG. 2(e). at nine points in time (hourly) during the charging process. The plug flow of 0.15 kg/s was calculated to charge the TES tank 8 hours. The x axis shows vertical position within the cavity receiver while the y axis shows temperature distribution inside it. During the first second, it can be noticed how very little diffusion occurs across the thermocline interface of TES tank. Calculation shows that in one second the temperature at the height of 1.398 m (2 mm below the top surface) was 250.17° C. and from this point to the bottom the HTF temperature remains the same at 250° C. After two hours the thermocline thickness was calculated between temperatures of 525° C. (at 1.06 m) and 275° C. (0.92 m). Giving a thermocline thickness of 0.14 m. After 5 hours the thermocline has a thickness of 0.222 m. At the end of the day, t=8 h, the TES tank is fully charged from the top till the height of 0.288 m but below 0.288 m the temperature is still lower than 550° C.

Likewise, a process in the same idealized tank with flow rate of half the rate assumed for the charging process but in the opposite direction resulting in a discharging process of 16 hours' duration is evaluated. At the beginning of the discharging process it is assumed that the HTF is at 550° C. everywhere. After the tank was brought in contact to a body at 250° C., in a second time period, the drop in temperature could be noticed. That is, slight temperature change is occurring at bottom, 2 mm thickness, of HTF and the rest is remaining at the same temperature, 550° C. After 2 hours, the thermocline thickness was calculated to be 0.142 m, between temperature levels of 525° C. (at 0.094 m) and 275° C. (at 0.234 m). Following this, the thickness of thermocline was changing with time. For instance, in 5 hours' time period a thermocline thickness is 0.22 m. Therefore, the comparison between discharging and charging periods at the same period of time make up the same thermocline thickness indicating it is not dependent on the flow rate. Moreover, thermocline thickness during the discharging period is much larger over the next hours. That is, at a height of 0.576 m the HTF is already at 250° C. and the temperature at the rest of the height is increasing as the height increases. Finally, the top is at 468° C. which is still sufficient to operate a typical power block comprising a steam generator, turbine and condenser.

In this section, the water tank theoretical calculations are presented with the assumption of contact of the two semi-infinite solid bodies. To be more precise, the conditions are the same time period, the same height of thermocline starting point and of course the properties of HTF are of water rather than salt because the experimental HTF is water. The mathematical model is identical to that used for molten salt calculations.

Once again, the contact of two semi-infinite solids as the idealized model of thermal diffusion is used. The whole TES tank is assumed initially to be at 30° C. and it is exposed to a flux sufficient to raise the tank's top surface temperature from 30 to 80° C. It means the initial temperature of the cold body A is at TA0=30° C. and of the hot body B is at TB0=80° C. (FIG. 2(d)). Additionally, plug flow is injected and distributed uniformly over the top of the tank by pumping certain amount of HTF from bottom to the top of the TES tank as shown in FIG. 1(e).

Thus, using the Eq.5, interface temperature Ti can be found:

$${T}_{i} = \frac{{T}_{A 0} * {T}_{B 0} )}{2} = \frac{30 ° C . + 80 ° C .}{2} = 55 ° C .$$

The charging period is taken as 75 minutes to make it identical to the experiment. As shown in FIG. 2(d), the interface between both zones A and B is referenced by Zi(t). As a plug flow is applied from the top of the tank, again Eq. 8 is used. Eq 6. is applied on both sides of the interface for each of the zones A and B of FIG. 2(d). In zone A, z<Zi and as: T0=TA0, Ti=55° C., TA0=30° C., thus from Eq. 6, Ti−T0=25° C. and x=Zi(t)−z. Hence, after simplification, the Eq 6 becomes:

$$T = 30 + 25 * erfc \frac{{Z}_{i} ( t ) - z}{{( 4 α t )}^{0.5}} \qquad Eq . 11$$

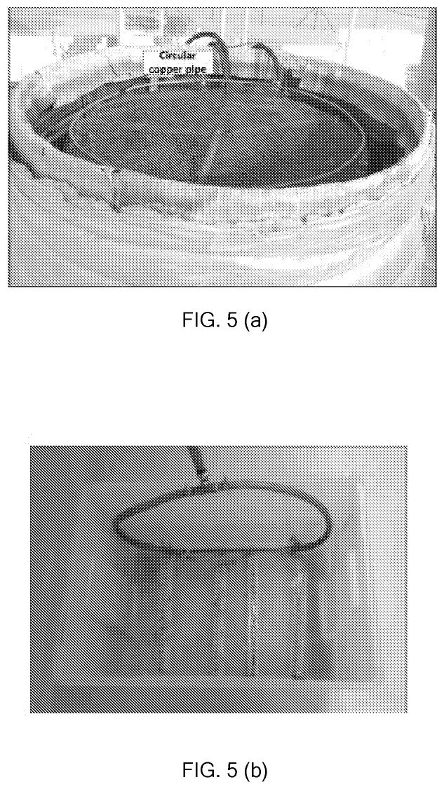

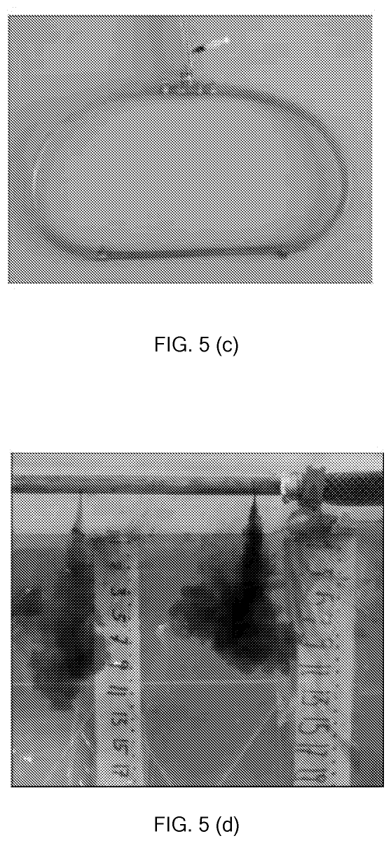

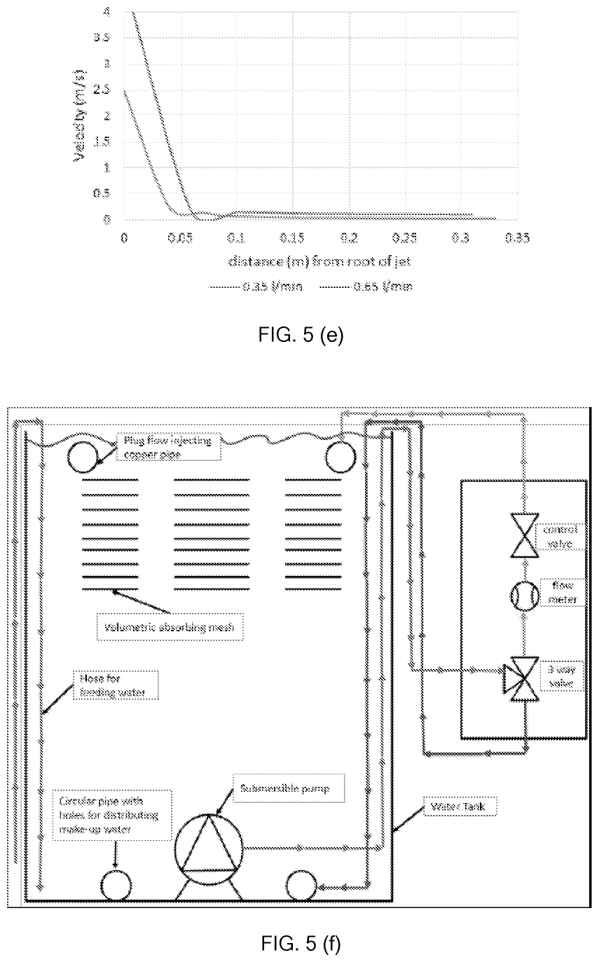

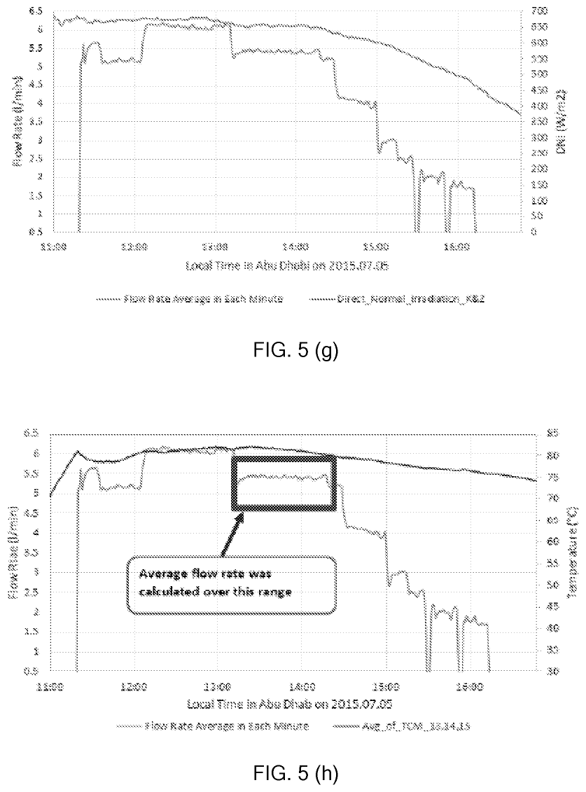

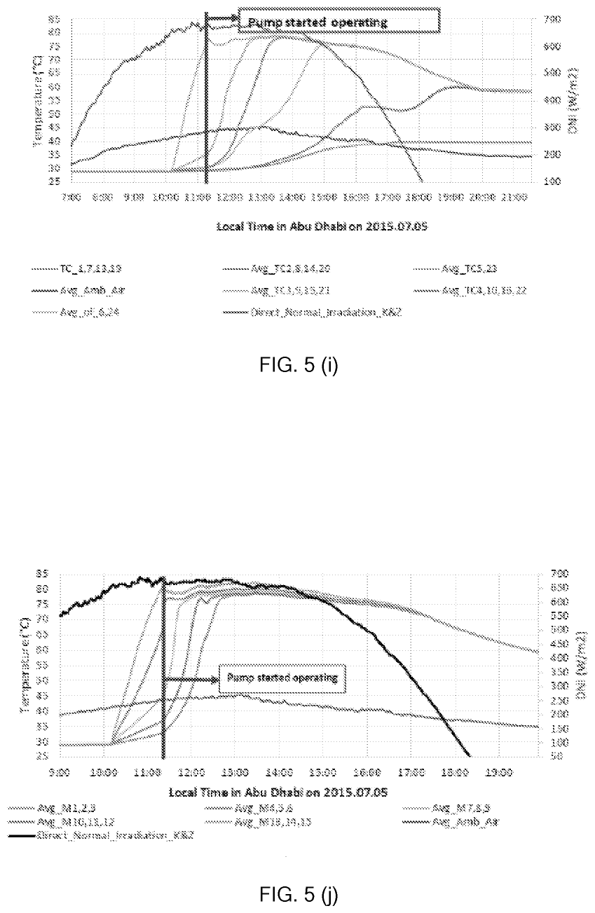

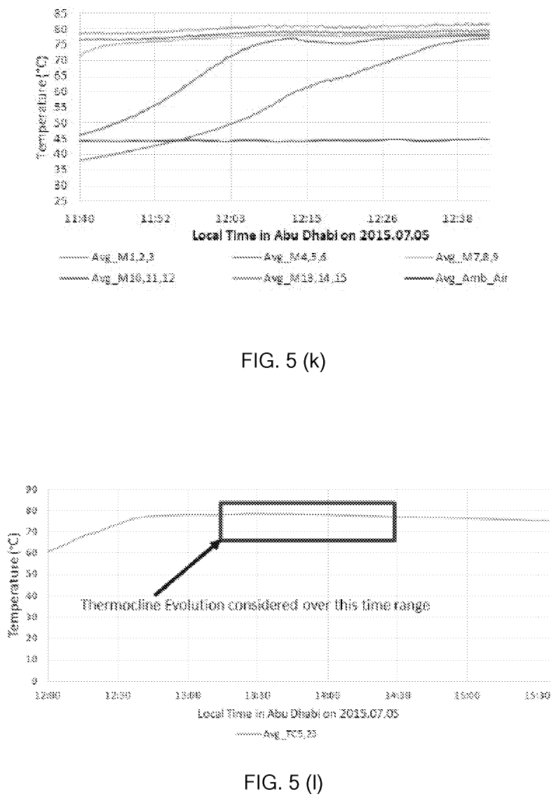

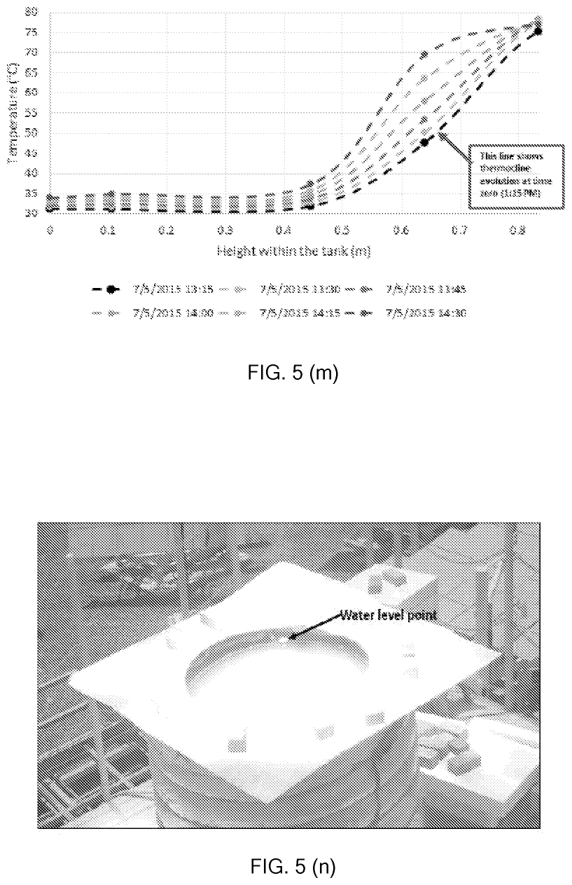

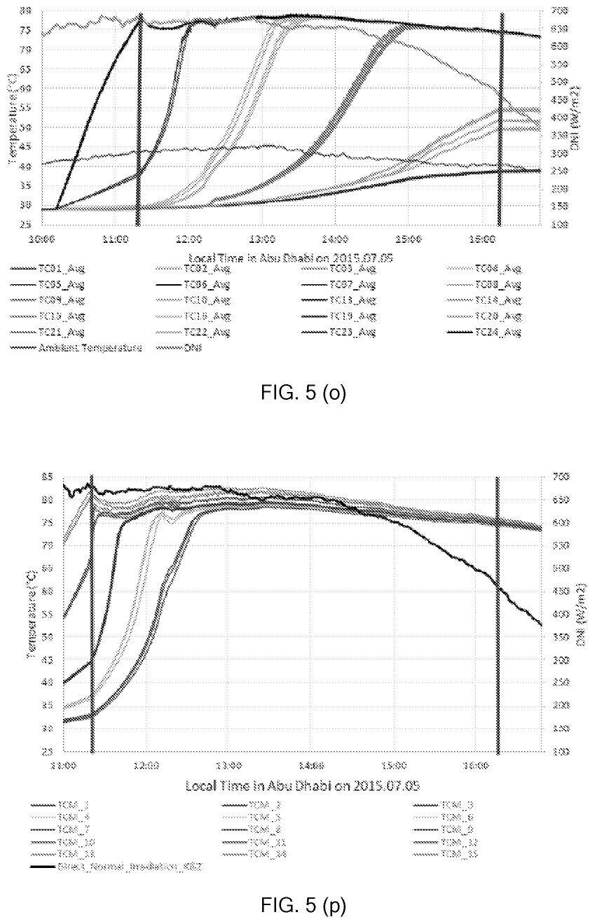

In zone B, T0=TB0, Ti=55° C., TB0=80° C., thus from Eq. 8, Ti−T0=−25° C. and x=Zi(t)−z, Hence, after simplification, the Eq. 6 becomes:

$$T = 80 - 25 * erfc \frac{z - {Z}_{i} ( t )}{{( 4 α t )}^{0.5}} \qquad Eq . 12$$

where: a=1.43E-07 m/s² Again, the following values are taken to calculate Eq. 8: Total charging time=4500 s, \dot{m}=0.089 kg/s (mass flow rate was chosen based on FIG. 5H), H=1.312 mm, M=2379.56 kg.

Before turning to the experimental work, the change in thermocline thickness based on theoretical calculations is briefly presented. The five temperature profiles shown in FIG. 2(g). correspond to the time steps for which experimental results will be presented further down. The height of the thermocline at time t=0 is taken to be 0.835 m as the experimental analysis was done from that height. In 15 minutes, temperature change is happening till 0.73 m from 0.77 (i.e. thermocline thickness is 0.04 m). The thermocline thickness is increasing in a similar way as the molten salt case presented earlier. After half an hour, the thickness of thermocline reached 0.06 m whereas in 45 and 60 minutes it showed 0.07 m and 0.08 m respectively. Finally, according to the calculations, in 75 minutes, the thermocline should end at a height of 0.23 m with a thickness of 0.09 m.

One of the original motivations for this effort was to measure concentrated incident solar flux at BDOE by constructing and using the water tank calorimeter. In order to estimate concentrated solar flux delivered by the BDOE, we designed a simple water tank calorimeter. An insulated water tank is placed at the focus of the BDOE and temperatures at different points of the tank are measured. Temperature measurements are used to determine the absorbed flux, and after estimating thermal losses, the incident flux maybe estimated.

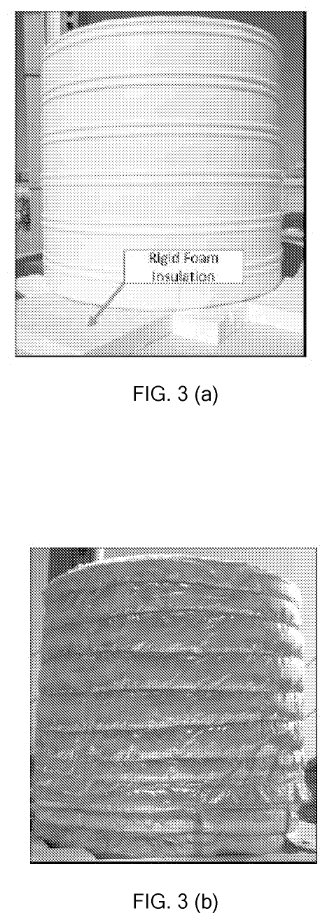

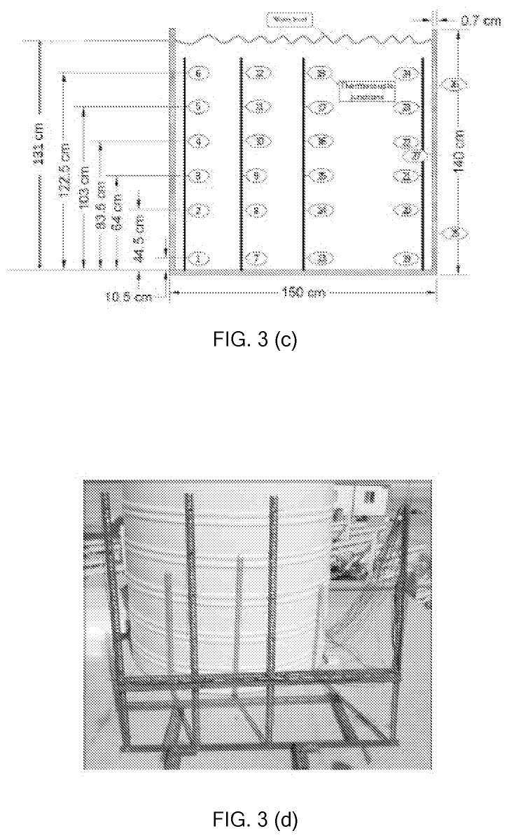

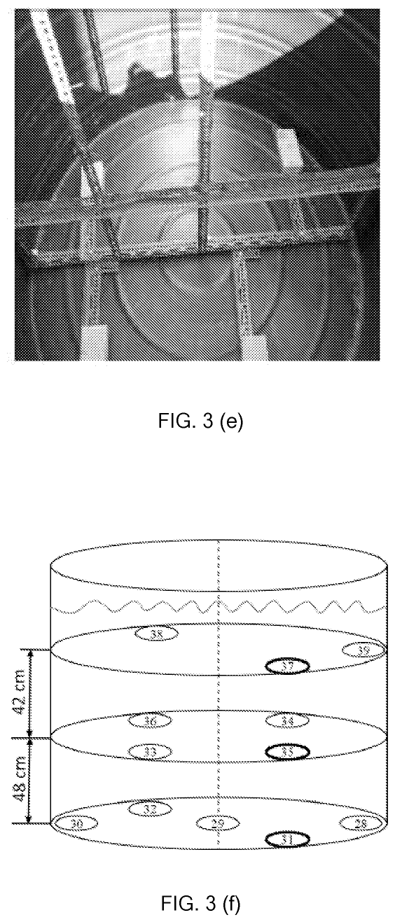

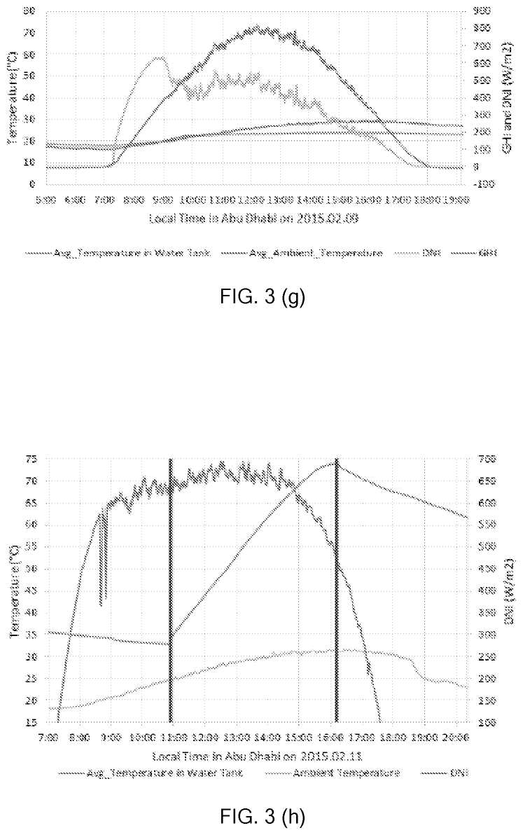

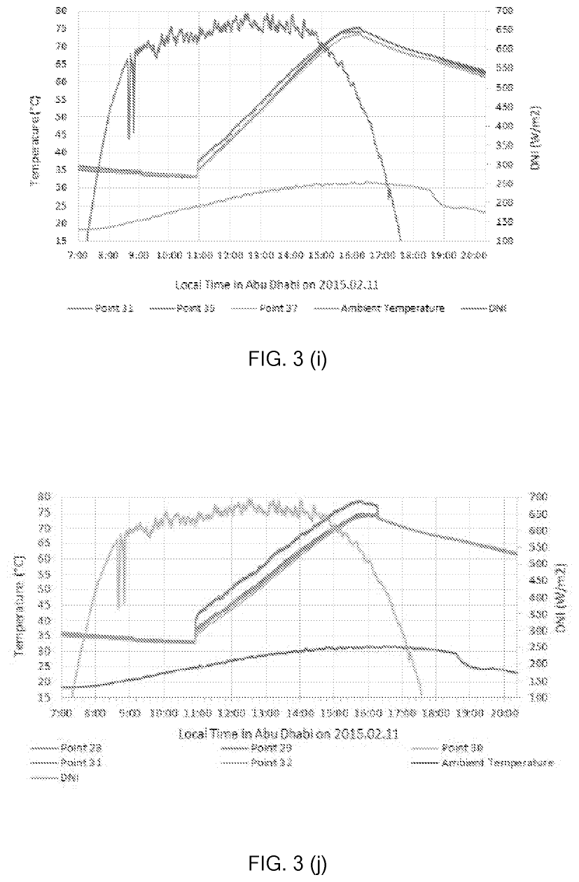

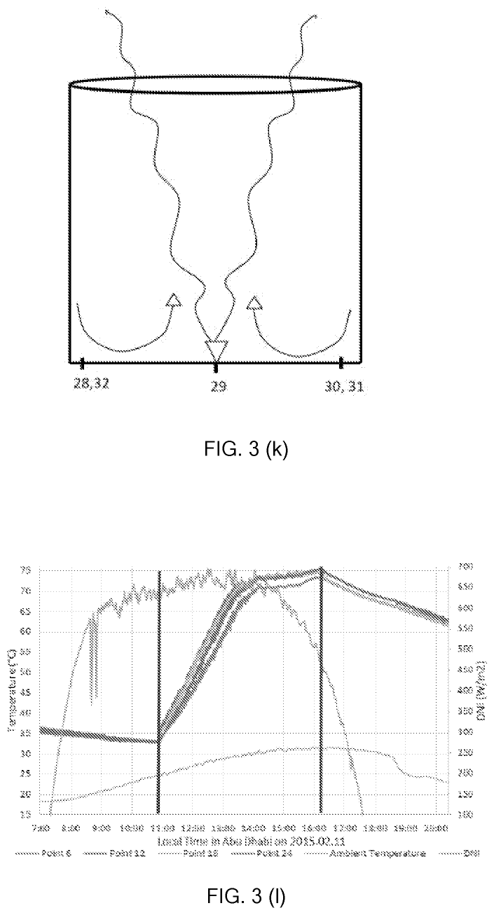

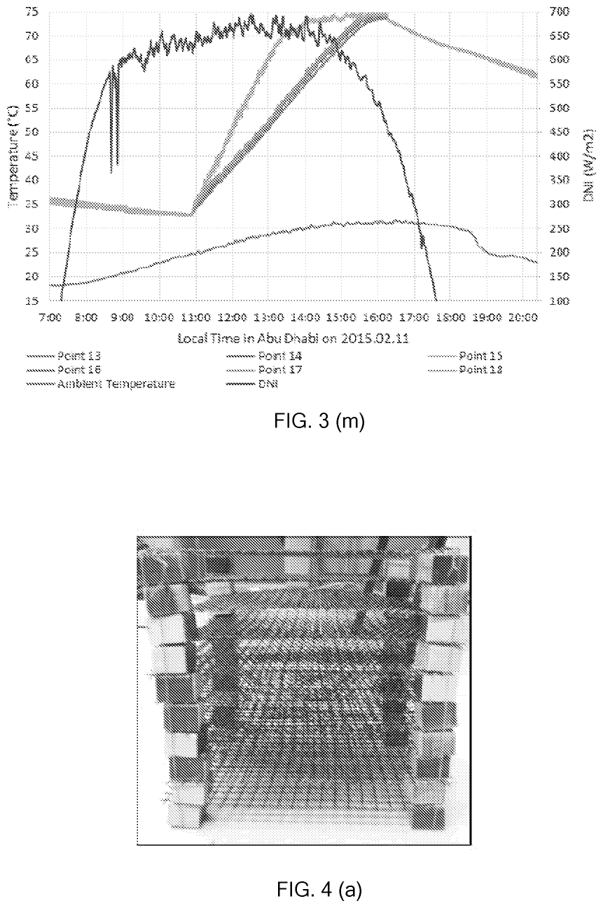

The PVC water tank was placed at the middle of the platform at BDOE as presented in FIG. 3(a). The followings are geometries of the PVC water tank: The height is 1.4 m, internal diameter is 1.53 m and wall thickness is 0.007 m. White rigid expanded polystyrene foam in 10 cm—thick blocks is used to insulate the tank from the bottom (FIG. 3(a)). The side walls of the tank are insulated with two wraps of 3 cm thick, foil backed fiberglass blanket (FIG. 3(b)). The thickness of the fiberglass insulation is around 0.02 m, and it has pinched areas with the rope.

Thermocouple (TC) wire with soldered junctions are placed to measure the temperature distribution inside the PVC tank. A TC tree was built with, shown FIG. 3(d) and there are 4 vertically placed slotted angles. The height of the slotted angle is 1.26 m but the highest TC has the height of 1.225 m. Six TCs are placed vertically on each slotted angle as shown in FIG. 3(d). The numbers inside the ovals in FIG. 3(c) shows the place of each individual TC. As can be seen on each horizontal line across the slotted angle risers, there are 4 TCs placed. For example, near the bottom of slotted angle, TC 1,7,13 and 19 are located on a horizontal line 10.5 cm above the tank floor. Furthermore, TC 25 and TC 26 are taped at the outside wall of the tank but TC 27 is taped at the inside wall of the tank.

FIG. 3(f) shows the TCs which are taped at the inner wall of the tank. On the bottom of the tank there are placed 5 TCs, which are TC 28,29,30,31 and 32. TC 29 is placed exactly at the middle bottom of the tank. One of the important installation objectives of these TCs is to measure the wall temperature so that when it reaches PVC's melting temperature to instantly stop the experiment in order to avoid damaging the platform. According to the lab test analysis the current PVC starts to soften at 116° C. Therefore, wall temperature must be kept below 116° C. Altogether, there are 37 TCs inside and 2 TC attached to the outside of the water tank.

To measure the exact amount of water inside the tank a 20-liter bottle was filled 124 times. When the bottle volume was measured its exact value was found to be 19.19 liters, therefore 124 bottles corresponds to 2379.56 liters. The reason for using the bottle to fill the tank is because the inner diameter of the tank is not the same everywhere, that is on the top of the tank it is 1.53 m and on the bottom it is 1.51 m. Also it has some additional volume in the ribs visible in FIG. 3(a). Hence, it was not possible by using simple equations of m=ρV and V=πr²h to measure the precise mass of water. Also, the TCs tree structure was put which takes additional volume and this could give inaccuracy to exactly measure the volume of the water inside the tank. The height of the water in the tank is kept at 1.312 m.

Using the measured mean temperature inside the water tank cavity receiver, the absorbed flux P_{absorbed} is calculated as follows:

$${P}_{absorbed} = \frac{Δ T}{Δ t} {M}_{Cp} \qquad Eq . 13$$

where: M—mass of the HTF (kg), Δt—time during the experiment (s), cp—specific heat of HTF (J/kg*K), ΔT—difference in temperatures from the beginning to the end of experiment (K). The incident flux P_{incident} is then estimated by using P_{absorbed} from the Eq. 14:

P_{absorbed}=P_{incident}−Pₗₒₛₛₑₛ Eq. 14

Also, Eq. 15 gives us the total losses during the experiment:

Pₗₒₛₛₑₛ=P_{cond}+P_{conv}+P_{rad}+Pₑᵥₐₚ+P_{ref} Eq. 15

where each term in Eq. 15 is defined as follows: P_{cond} is a conduction loss term which takes into account the losses from the base, P_{base} and side wall of the tank P_{wall} and calculated as follows:

P_{cond}=P_{base}+P_{Wall}=(A₁U₁+A₂U₂)(Tₜₐₙₖ−T_{ambient}) Eq. 16

where: P_{base}—conduction loss through base of water tank (W), P_{wall}—conduction loss through wall of water tank (W), A₁—base area (m2), A₂—wall area (m2), U₁—overall heat transfer coefficient of base (W/m2K), U₂—overall heat transfer coefficient of wall (W/m2K), Tₜₐₙₖ—mean temperature during the experiment (K) and T_{ambient}— average ambient temperature during the experiment (K).

To find the overall heat transfer coefficient, the calculation should be for base and side of walls of the tank. Therefore, to find the overall heat transfer coefficient from the base of the tank U1, the below equation is used. For the base of tank:

$$\frac{1}{{A}_{1} {U}_{1}} = \frac{{dx}_{1}}{{k}_{PVC} {A}_{1}} + \frac{{dx}_{2}}{{k}_{rigid foam} {A}_{1}} + \frac{{dx}_{3}}{{k}_{galvanized iron} {A}_{1}} \qquad Eq . 17$$

### Where:

A₁—an area which is equal to A=π²(m²), r—radius of base of the tank (m) and k—thermal conductivity (W/m·K). Because conduction at the base of the tank happens through PVC, rigid foam insulation and platform which has material of galvanized iron, the thickness dx and thermal conductivity k of each material is chosen accordingly. For the side wall of the tank, the overall heat transfer coefficient U₂ is obtained from the following equation:

$$\frac{1}{{A}_{2} {U}_{2}} = \frac{ln ( \frac{{r}_{2}}{{r}_{1}} )}{2 π {k}_{PVC} L} + \frac{ln ( \frac{{r}_{3}}{{r}_{2}} )}{2 π {k}_{fiber glass} L} \qquad Eq . 18$$

Where: r₁—inner radius of the tank (m), r₂—outer radius of the tank (m), r₃—radius of the fiber glass insulation (m) and L-height of the wall (m). Second term in Eq.15 is convection loss P_{conv} which is equal to [7]:

P_{conv}=A*h_{conv}*(Tₜₒₚ_{_{receiver}}−T_{ambient}) Eq. 19

A—top surface area of the tank (m²), h— heat transfer coefficient (W/m²K), T_{top reciever}—average water temperature on top of the tank (K). Following this, the third term in Eq. 15 is radiation loss P_{rad} which is calculated using the following equation:

P_{rad}=A*ε*σ*(Tₜₒₚ_{_{receiver}}⁴−T_{ambient}⁴) Eq. 20

where: A—top surface area of the tank (m²), ε—effective emissivity for radiant exchange between surface and surroundings, σ-Stefan's constant which is equal to σ=5.6703*10⁻⁸ W/m²K². The fourth term in Eq. 15 is evaporation loss and in order to evaluate the evaporation loss the data presented in Table 1 is used.

TABLE 1
Evaporation and Radiation Losses with respect to temperature
[EngineerToolbox.com, 2015]

| | Heat Loss from Liquid Surface | | |
|---|---|---|---|
| Water | (Btu/ft²hr) | | |
| Temperature | Evaporation | Radiation | |
| (° F.) | Loss | Loss | Total |
| 90 | 80 | [symbol] | 130 |
| 100 | 160 | 70 | 230 |
| 110 | 240 | 90 | 330 |
| 120 | 360 | 110 | 470 |
| 130 | 480 | 135 | 615 |
| 140 | [symbol] | [symbol] | [symbol] |
| 150 | [symbol] | [symbol] | 1040 |
| 160 | 1100 | 210 | [symbol] |
| 170 | 1360 | 235 | [symbol] |
| 180 | 1740 | [symbol] | [symbol] |
| 190 | 2160 | 290 | [symbol] |
| 200 | 2680 | 320 | 3000 |
| 210 | 3240 | 360 | [symbol] |

[symbol]

indicates data missing or illegible when filed

Finally, the last term in Eq. 15 is reflection loss P_{ref} from the surface area of the water tank, which is calculated using the following formula:

P_{ref}=P_{incident}*ρ Eq. 21

Where ρ—reflectance of the surface of a material

Another way of estimating the incident flux is to compute it from the direct normal irradiation (DNI), using the BDOE optical model, verification of which is the object of the water tank colorimeter:

P_{incident}=C*DNI*A_{HS}*f_{cos}

Where A_{HS}=Total surface area of HS facets, A_{HS}×f_{cos}=projected area of HS facets≈Σ_{HS}^{Nnhs} cos (θₕᵢₛ) C—effective concentration ratio=C_{geometric}*η (zenith, azimuth)*(1−fₛₚ), fsp—receiver spillage factor (1−fₛₚ is the intercept factor) which does not include CR spillage and η—optical efficiency accounting for shading and blocking and CR spillage.

The water tank calorimeter experiment was carried out on February 10 and 11, 2015. However, on Feb. 10, 2015 after running the experiment, it was realized that TCs, labeled as 25, 26, 27, 38 and 39, were not working properly and hence they were fixed at 17:04 on the same day. Also, calculations from Feb. 9, 2015 do not take into account TCs which were not working properly (TC 25, 26, 27, 38 and 39). Therefore, it was decided that only results of the experiment on Feb. 11, 2015 should be analyzed. Tank temperature data was obtained without running heliostats (HS) on Feb. 9, 2015 to compare the water tank temperature, ambient temperature and the DNI as shown in FIG. 3(g). It is interesting to note that the sunrise time was at 7:01 AM on Feb. 9, 2015 and minimum ambient temperature during the night was recorded to be 16.139° C. at 7:00 AM and also it was dropping steadily just before the dawn.

It can be seen that as ambient temperature rises the water temperature is also increasing; however, water temperature did not rise as much as ambient temperature. For example, at 15:07 ambient temperature peaked at 29° C. but water temperature reached only 24° C. In addition, a sharp temperature rise occurred in water tank between 8:58 AM and 9:51 AM as the ambient temperature also increased at that time period.

The calorimeter experiment started on Feb. 11, 2015 at 10:54 AM with 22 heliostats. FIG. 3(i) shows average temperature in water tank during the experiment with respect to ambient temperature and DNI. When the 22 heliostats are focused at 10:54, there is a significant rise in water tank temperature and a gradual rise continues until the experiment was stopped at 16:17. To summarize, at 10:54 AM the average temperature in water tank was at 32° C. and at the end of the experiment it was at 73° C. Following this, water tank temperature decreased gradually from morning (e.g. 7:12 AM) until the start of experiment even though the ambient temperature was increasing during that period. The reason for this is that on 2015 Feb. 10 the HS field ran all day hence water tank temperature having increased during the daylight hours of Feb. 11, 2015 although decreasing all night before the experiment. During the experiment the DNI reached a peak at 13:24 and at 14:03 which was 691 (W/m2). It is also seen in 3f. that the DNI was almost constant between 11:00 AM till 14:00 (shown between the two red vertical lines). Therefore, it was decided to use the temperature values of water tank and ambient in this periods for the numerical analysis to measure the concentrated solar flux.

Temperature trajectories on three different levels on the wall of water tank can be seen in FIG. 3J 35 rises and crosses over TC 31 after 15:00 and remains ˜2 K above the other wall temperatures as they all decay towards ambient in late afternoon and evening.

The temperature distribution at base of water tank at different points was also observed. It is seen from FIG. 3(k) and FIG. 3(l). that temperature at the center (TC 29) of water tank was around 4° C. higher than the other (TC 28, 30, 31 and 32) points. This shows that radiation absorbed is much higher near the center because the central reflector is concentrating towards the middle of the platform.

FIG. 3(m) illustrates the temperature distribution on top zone of water tank (height is 1.2 m shown in FIG. 3(b). Temperature at TC 12 and 18 is increasing slightly more than TC 6 and 24. Following this, temperature at TC 6 is obviously increasing less than others; however, it is normally expected to be at the same temperature as TC 24, because they are symmetric. It may be an indication of non-symmetric incident flux or it may be an indication of TC installation difference affecting the relative influence of irradiation on different TCs. Once temperatures reached almost 77° C. the HS field was stopped from operating at 16:17.

The evolution of temperatures distribution on different height levels inside the water tank are in FIG. 3(n). As can be seen the temperature at TC 18 is increasing much faster than the others but it became almost constant at 15:36 in the middle of the water tank. Here, it is interesting to compare the temperature values recoded by TC 29 (FIG. 3(l)) and TC 13 (FIG. 3(n)) as they were placed closely to each other, but TC 29 was at the wall and TC 13 just 0.1 m above it. It can be noticed that there is 8° C. temperature difference between them at 12:14 PM. This can explain the fact that actually the wall of the tank absorbs in coming solar flux and after being heated up, it is heating the water. That is water is being heated by the wall through a process of thermal convection.

The average temperatures of water tank and ambient, between 11:00 AM and 14:00 PM were 48° C. and 27° C. respectively and the average DNI was 661 (W/m²) during that period of time. Furthermore, for the conduction loss calculation the average water tank temperature is used but for the convection and radiation calculations the average of TC 6, 12, 18 and 24 is used (FIG. 3(c)) as the both of the losses occurs from the top layer of water tank. The average temperature recorded by TC 6, 12, 18 and 24, between 11:00 AM and 14:00, is 55.4° C.

Using the Eq. 13, the absorbed flux can be found and ΔT is the temperature difference in the water tank from 11:00 AM until 14:00. Also, specific heat of water is taken as 4.1802 (kJ/(kg K)).

$${P}_{abso rbed} = \frac{Δ T}{Δ t} M {c}_{p} = 13.75 kW$$

Following this, to find the incident flux, the total losses should be calculated which include conduction, convection, radiation, evaporation and reflective. To calculate the conduction loss Eq. 16 is used and as conduction loss occurs through the wall and the base of the tank, we also need to solve Eq. 17 and Eq. 18.

The thicknesses of PVC, rigid foam and galvanized iron are dx₁=0.007 m, dx₂=0.01 m and dx₃=0.015 m. The thermal conductivities of PVC, rigid foam and galvanized iron are k_{pvc}=0.19 (W/mK), k_{rf}=0.03 (W/mK) and k_{gal iron}=2.88 (W/mK). The base area of water tank is A1=πr²=1.79 m² and hence Eq. 17 gives U₁=0.22 (W/m²K). To calculate Eq. 18 we need the radii, r₁, r₂ and r₃. r₁=0.765 m, r₂=0.772 m and r₃=0.787 m. Also thermal conductivity of fiber glass insulation is needed which is equal to k_{fiber glass}=0.04 (W/mK). Using these values, Eq. 18 gives us:

A₂U₂=16.62 W/K. thus, P_{cond}=358.3 W

Convection loss is calculated using the Eq. 19 and the heat transfer coefficient is taken as h=10 (W/m²K).

P_{conv}_{ₗₒₛₛ}=A*h_{conv}*(Tₜₒₚ_{_{receiver}}−T_{ambient})=511 W

The radiation loss is calculated using the Eq. 20. The emissivity of water taken as ε=0.98 [17].

P_{rad}=A*ε*σ*(Tₜₒₚ_{_{receiver}}⁴−T_{ambient}⁴)=354 W

The Table 1 is used to find the evaporation loss using the average temperature of 55.4° C., which is listed as 3 kW. To calculate the incident flux, Eq. 14 is re-written as mentioned below and the spectral reflectance of water is taken to be 20%.

P_{absorbed}=P_{incident}(1−ρ)−Pₗₒₛₛₑₛ₂

Plosses₂ includes conductive, convective, radiation and evaporation losses, therefore:

$${P}_{incident} = \frac{{P}_{absorbed} + {P}_{losses 2}}{( 1 - ρ )} = 22.5 kW$$

Since the calculated P_{incident} pertains to the case where 22 HSs were in operation, an estimation for the case of 33 HSs in operation is done as follows:

$${P}_{incident\_ 33 HS} = \frac{33 * 22.5 kW}{22} = 33.75 kW$$

Now, solving for P_{absorbed} for 33 heliostats would be:

$${P}_{absorbed\_ 33 HS} = {P}_{incident\_ 33 HS} ( 1 - ρ ) - {P}_{losses 2} = 33.75 kW ( 1 - 0. 2 ) - 4.2 kW = 22.48 kW$$

As the average DNI on the day of experiment (between 11:00 and 14:00) was measured as 661 W/m² therefore using this in the following equations we can evaluate concentration ratio.

$${P}_{incident} = C * DNI * Area ;$$

$$Gives \text{:} C = \frac{{P}_{incident\_ 33 HS}}{DNI * Area} = \frac{33750 W}{661 \frac{w}{{m}^{2}} * 1.84 {m}^{2}} = 27.74 suns$$

In order to establish natural stratification inside the water tank, it is necessary to have two separate temperature zones, one being high temperature zone and other low, inside the water tank. To achieve this goal, it was planned to place a volume mesh absorber at the top of the water tank which will transfer heat to water around it but will not necessarily produce a uniform temperature. Therefore, a mesh volume absorber was built using woven wire mesh made of black anodized stainless steel.

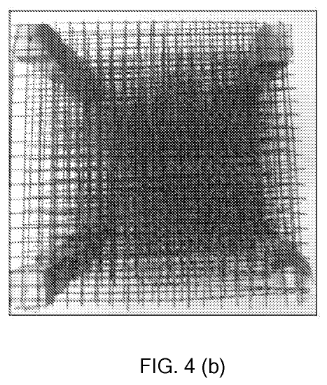

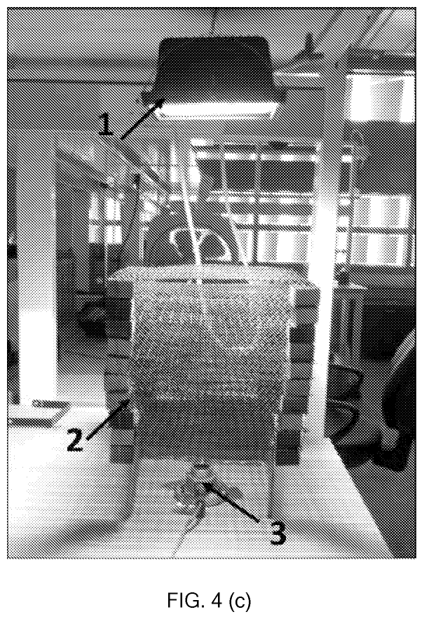

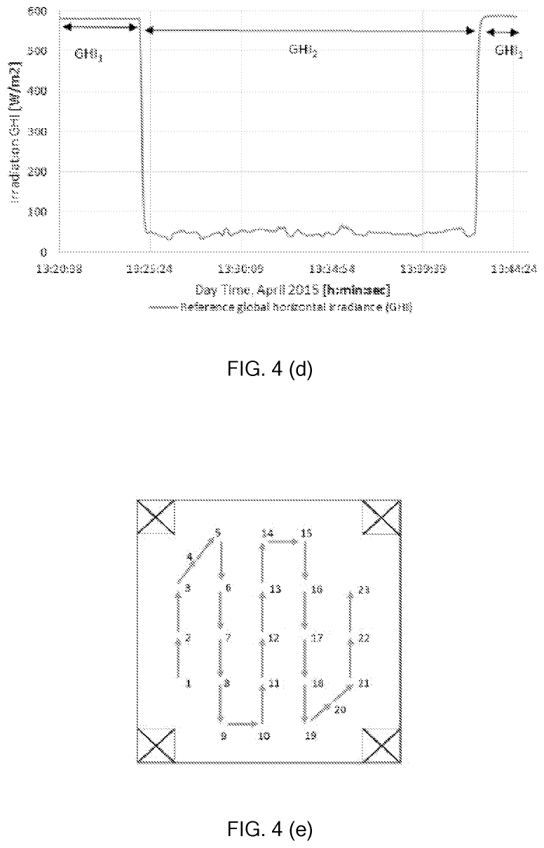

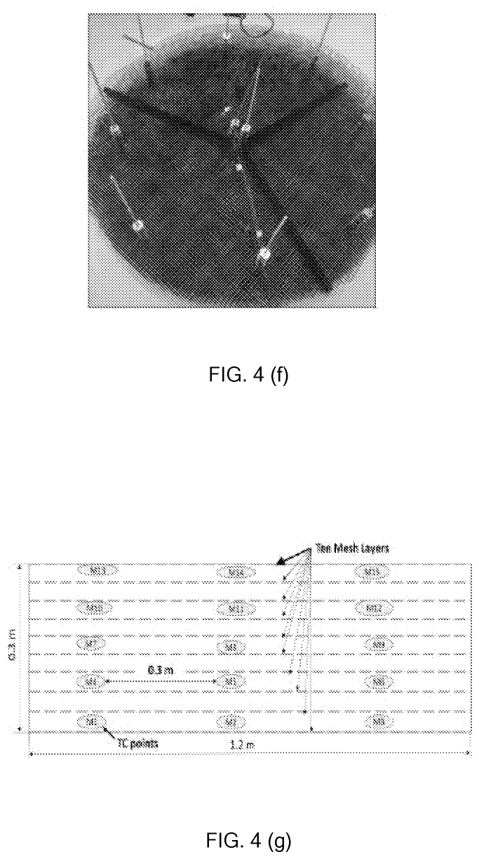

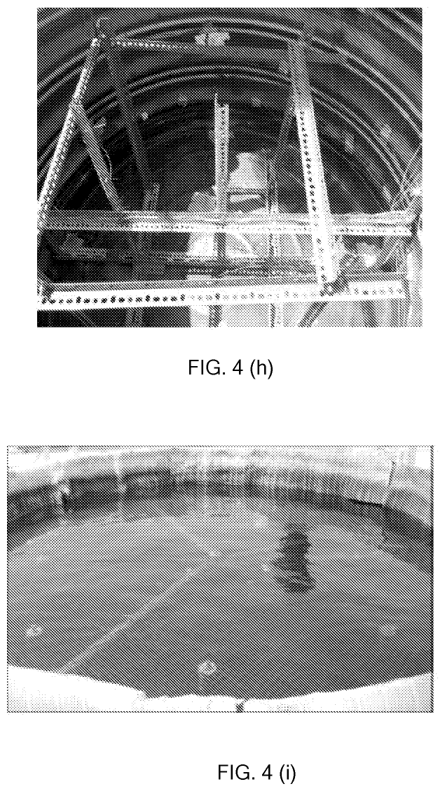

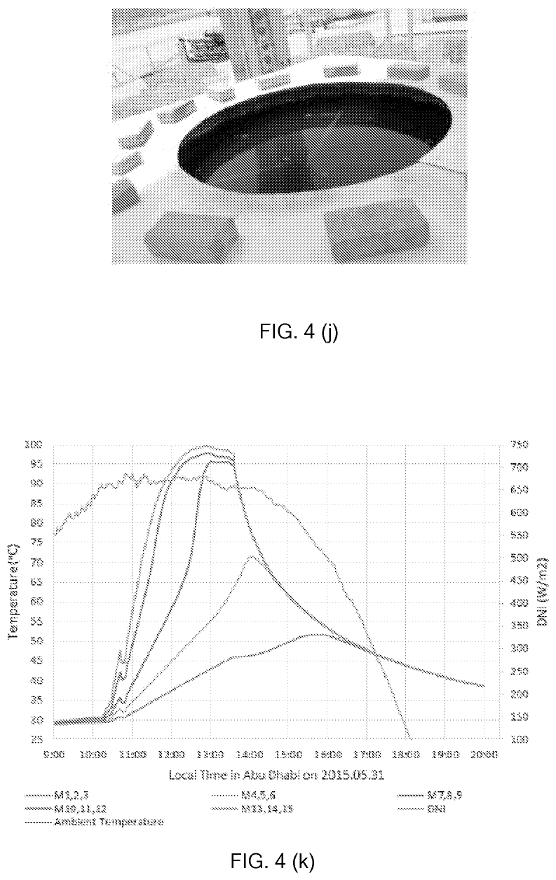

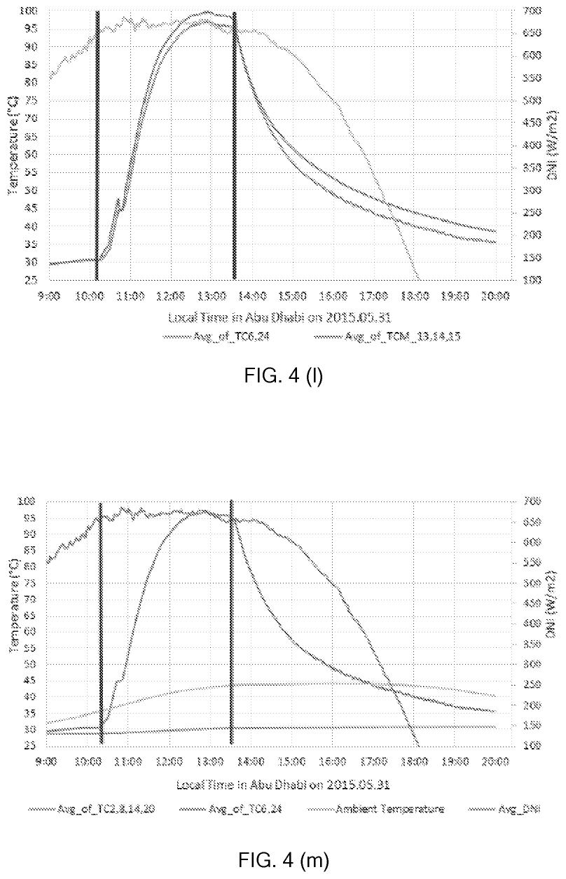

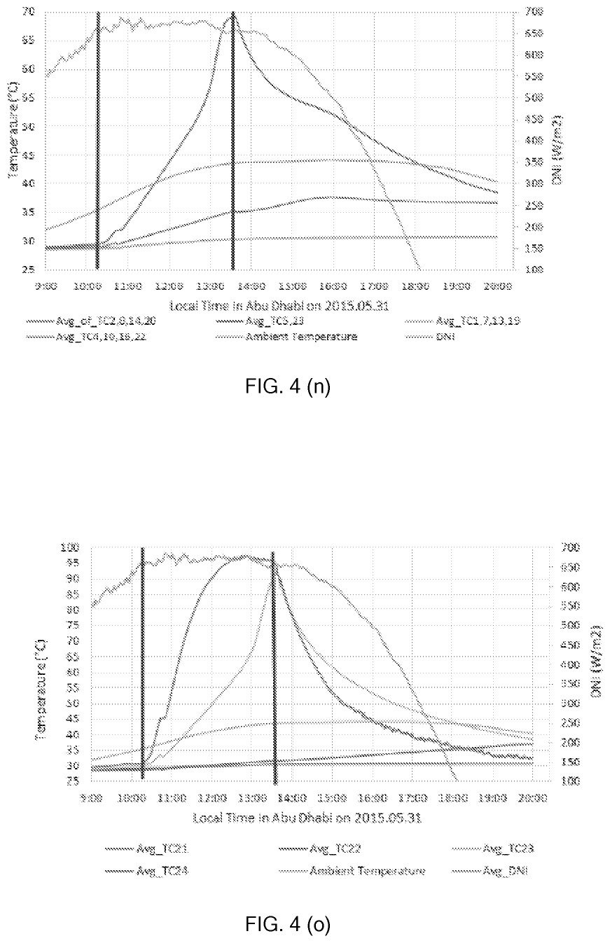

Initially the small scale mesh was built and tested for its absorptance. The main objective of the small scale mesh was to analyze whether chosen mesh size and number of layers are right. Therefore, a 10 layer of small scale mesh assembly was built as shown in FIG. 4(a) and FIG. 4(b). In an embodiment of the present invention, the absorbing mesh comprises multiple layers deployed along a vertical axis of the tank between the basis and the opening of the tank, preferably the top 10% or less in order to approach maximum exergy at the end of the charging period.

The optical porosity of mesh (ττii) can be stated as the ratio of open area of the screen to its total area given by Eq. 22.

$${τ}_{i} = \frac{Open area}{Total area} \qquad Eq . 22$$

In our case, the diameter of the mesh's fiber was 0.001 m, pitch was 0.011 m, open and total area of the top view was 0.0001 m² and 0.000144 m² respectively, hence 6=0.826. For N randomly oriented layers the total transmittance is expected to be approximately τ=τi^{N}=0.148 when N=10. To test the absorptance of a volume mesh absorber (2), small apparatus was constructed using a halogen lamp (1) and pyranometer (3) shown in FIG. 4(c).

The height of the pyranometer from the surface of the table is 0.061 m. The distance between surfaces of the table to bottom of the mesh, top of the mesh and lamp bulb is 0.103 m, 0.343 m and 0.637 m respectively. The (X,Y,Z) positions of the lamp and pyranometer are rigidly fixed with respect to each other. During the experiment the volume mesh absorber was moved very slowly over top of pyranometer to check the absorptance through different X,Y (FIG. 4(e)) points of the mesh structure. The square boxes at the corner of FIG. 4E represents block points where the pyranometer could not reach while the volume mesh absorber was being moved very slowly over top of it. The FIG. 4(d) and FIG. 4(e) demonstrates the experimental results obtained with and without a mesh. As seen in FIG. 4(d) the incident radiation, which we will call GHI, dropped rapidly at 13:24 because at that time the mesh was placed and, over the next 17 minutes before taking it out, the volume mesh absorber was slowly moved on top across of the pyranometer, after which the mesh was removed and GHI returned to its initial value.

Subtracting the 17-minute average of GHI2 (49 W/m²), while mesh was top of the pyranometer, from the average overall GHI1 (568 W/m²) recorded by pyranometer without a mesh on top of it and dividing this difference by GHI1, gives us the absorptance of the mesh shown in Eq. 23. Thus, the absorptance of the volume mesh absorber is 91.4%, which is sufficient for our purpose.

$$Absorptance = \frac{{GHI}_{1} - {GHI}_{2}}{{GHI}_{1}} = 0.914 \qquad Eq . 23$$

Once the absorptance was tested with a small scale mesh assembly, using the same parameters and material of mesh but different size, a large scale mesh was built to install inside the water tank as shown in FIG. 4(f) and FIG. 4(g). The shape of the large mesh was circular with a diameter of 1.2 m as shown in FIG. 4(f) and FIG. 4(g).

There are also 10 layers of mesh in the large scale device and 15 thermocouples were installed in every other layer as shown in FIG. 4(g). The thermocouples are labelled as M1 to M15 and their distance between each other is 0.3 m. To support the mesh, the slotted angle iron inside the water tank (FIG. 4(h)) was rebuilt such that when the mesh is placed, its top layer should be submerged 0.1 m. The radiation shield, with a diameter of 1.1 m, (FIG. 4(j)) was positioned on top of the tank to decrease the aperture area as the mesh diameter was only 1.2 m whereas water tank had a diameter of 1.53 m.

The experiment started at 10:15 AM on May 31, 2015 with 9 HS, and after 15 minutes another 16 HS were added for a total of 25. Additionally, after the experiment started a smog was noticed on top of the tank, hence HS field was stopped for 2 minutes, and then it again started. On the temperature-versus-time plots (FIG. 4(k)-4(o)) this can be noticed easily as the temperature dropped in that 2 min time period. Vertical red lines show the starting time (10:15 AM) and ending time (13:36 PM) of the experiment.

Temperature distributions inside the mesh volume absorber can be observed from FIG. 4(i) and FIG. 4(j). It can be seen that as soon as the experiment starts temperatures in the top layers of mesh increased considerably. The small drop between 10:48 and 10:50 AM, is the time period to check the smog on top of the water tank, and the temperature in the other layers was still rising. Following this, temperatures at thermocouples M 13-15 were rising rapidly, rising temperatures can be noticed also at M 10, 11, 12 and at M 7, 8, 9 but these are rising gradually. Moreover, the temperature recorded by M7, 8, 9 reflects an interesting behavior at 12:28 PM.

The temperature has been rising at M7,8,9 at a moderate rate until 12:28 PM after which it is increasing rapidly while temperature at M10,11,12 having almost reached boiling point, are no longer rising. Therefore, by advection heat is moving from M10, 11, 12 to M7,8,9. In addition, DNI is dropping at 12:57 PM and hence it is causing the temperature drop at the points of M7,8,9; M10,11,12 and M13,14,15. Finally, when the heliostats are defocused and the pump has stopped at 13:36 the temperature at M7,8,9; M10,11,12 and M13,14,15 dropped significantly. However, temperature is still rising at points of M1,2,3 and M4,5,6 as the heat is transferring from the top layers of mesh to the bottom by virtue of diffusion.

The comparison of temperature distribution inside the mesh TCM 13,14,15 (elevation of 0.128 m) and outside TC 6,24 (elevation 0.1225 m) with approximately the same elevation is presented in FIG. 4K. It is obvious that even though the heights of TC 6,24 and TCM 13,14,15 are nearly the same, the temperature inside the mesh is nearly 4° C. higher during the experiment. Temperature comparison at different levels inside the water tank can be observed from FIG. 4(m), FIG. 4(n) and FIG. 4(o). There is a significant difference in temperature between the top and bottom zones of the water tank. For example, FIG. 4(k) shows that temperature near the bottom (TC 1,7,13,19) at z=10.5 cm of the water tank is almost at uniform 30° C. while recorded temperature by TC 5,23 at z=103 cm is reaching nearly 70° C. by the end of the experiment.

Temperature increases at the bottom of the water tank very little even as the ambient air temperature is going up indicating that little of the incident radiation penetrated to the bottom of the tank. In FIG. 4(o) on the other hand we see that the temperature at floor of tank is nearly constant at around 30° C. Clearly most of the incoming solar irradiation is absorbed on top layers of the mesh resulting in strong temperature rise at the top of the tank. Thus it appears that a volume mesh absorber may help to establish and maintain natural stratification inside the water tank.

The desired well-stratified behavior of the coupled absorber-TES concept is based on the assumption of plug flow as described earlier and used for ideal thermocline analysis earlier. Therefore, special attention is directed toward the design of a suitable plug flow injection system. The coupled receiver-tank experiment is then described. Plug flow should prevent overheating near top of the absorbing mesh by introducing cold fluid above the mesh. The plug flow injection system consists of a circular pipe with in-ward directed jets placed on top of the volumetric mesh absorber as shown in FIG. 5(a).

FIG. 5(b) describes the apparatus for testing the ability of inward directed jets to promote plug flow. The rectangular tray (a) shown on the left side of the FIG. 5(b) has ruler on the base with length of 0.32 m. Copper pipes with different number of holes, pitches and hole diameters are mounted to the hose. The tray (a) is filled with water and copper pipe is submerged in it. Then, water is pumped with different flow rates through the hose so that it mixes with the water inside the tray. The objective was that the pumped water should travel around 0.6 m with the given flow rate. The propagation distance of the jets was measured by injecting dye into the water supply pipe, in order to distinguish pumped water from still water as shown in FIG. 5(c). Thus, by observing the movement of colored water with respect to time and with the given flow rate of water, it was possible to find out the velocity at different distances from where the jet entered the still water. The flow rate of injected water was varied between 0.5 and 6 l/min according to the calculations described in 5b.

The experiments were carried out to find propagation distance of jets produced by different pipes and different hole diameters. Three different geometries were tested: The first group of pipes had internal pipe diameter and hole diameter in the pipe of 0.012 m and 0.003 m respectively with pitches of 0.015, 0.03, 0.06 and 0.11 m. The second group of pipes had internal pipe diameter and hole diameter in the pipe of 0.012 m and 0.0025 m respectively with pitches of 0.03, 0.06 and 0.11 m. The final copper pipe had a wall thickness of 0.0013 m, external diameter of 0.013 m, the pitch between 3 holes was 0.12 m and the hole diameter was 0.0015 m.

The experiment was recorded by using a video camera. The captured videos in .mov format were divided into frames (FIG. 5(d)) by using the software “Free video JPG converter” to find the velocity of flow. In order to find the travel time the video time was divided by total number of picture frames. Then it was multiplied by the number of frames between dye emergence (from the pipe's holes) and dye propagation to a given distance.

FIG. 5(e) shows how the propagation distance is varying with respect to velocity of the jet. As can be seen, the velocity is decreasing significantly as soon as the jet comes out of the hole. It is basically because the cross sectional area of the jet is increasing with distance from the pipe.

After the flow travels some distance the velocity decreases significantly and becomes near zero. The velocity at 0.3 m is recorded as 0.05 m/s at 0.35 l/min flow rate. And for a flow rate of 0.65 l/min the velocity at 0.3 m was 0.1 m/s. This means, each hole has flow rates of 0.21 and 0.11l/min for 0.65 and 0.35 l/min respectively. Also, in order to have the estimated values of flow rate for the plug flow injection system for the day of experiment, the calculations were done in advance. The DNI was measured on a clear sky day in summer and assuming that the DNI is more or less constant for the days of summer, the flow rate was estimated beforehand using this DNI value, for the purpose of calculating the required number of holes. According to those calculations the flow rate during the day of the experiment should be between the range of 2.5 and 6.5 l/min Hence, by dividing 6.5 by 0.21 and 2.5 by 0.11 it is decided to have 29 holes for the circular copper pipe with diameter of 1.11 m. and to have a pitch of 0.120 m.

The volumetric absorbing mesh was placed at the top section of the water tank to absorb the incoming solar irradiation with the purpose of establishing the natural stratification as already explained of a large scale volume mesh absorber. Once the natural stratification was established it was desired to move the thermocline evolution from top of the tank downward by injecting plug flow from top of the tank as shown schematically in FIG. 5(a). To obtain the required low flow rates from the high flow rate submersible pump on hand we did some alterations to adjust the flow rate of the submersible pump to the desired value. Cold water was pumped from the bottom of the tank to the three-way valve and there it was divided in two flows. One flow went back into the bottom of the tank and distributed uniformly at the base to avoid turbulence. The other one went through the flow meter and control valve and finally connected to the plug flow injecting copper pipe shown in FIG. 5(a). The flow rate which was coming to the plug flow injecting pipe was recorded by a flow meter. Also, additional hose for feeding water to maintain the height of water at the same level during the experiment was submerged near the bottom of the tank. The flow rate of water \dot{m} (kg/s), to maintain selected charging temperature (Tₜₒₚ=80° C.), was found by using Eq. 24.

$$\dot{m} = \frac{{\dot{Q}}_{i} - {\dot{Q}}_{e} - {\dot{Q}}_{r}}{{c}_{p} ( {T}_{top} - {T}_{bottom} )} \qquad Eq . 24$$

### Where:

\dot{Q}ᵢ=\dot{Q}_{id}*ρ_{HS}*ρ_{CR}*N*DNI Eq. 25

\dot{Q}ᵢ—incident solar flux (W), Qₑ—evaporation loss from the top of the water tank (W), Qᵣ—radiation loss from the top of the water tank (W), Tₜₒₚ=80° C.—temperature on the top layer of the mesh (° C.), T_{bottom}=30° C.—temperature at the bottom layer of the mesh (° C.), \dot{Q}_{id}—ideal incident solar flux (from ray tracing model) (W), ρ_{HS}—reflectivity of heliostats (a weak function of incident angle but assumed constant), and ρ_{CR}—reflectivity of central reflector, N—number of heliostats and DNI—direct normal irradiation (W/m²).

To estimate the ideal incident solar flux during the day, a ray tracing optical model was used for the day of 2015 Jul. 5. However, since the optical model does not take into account real value of reflectivity for CR and HS, and the actual DNI, the Eq. 25 was adopted to calculate the actual incident solar flux. Following this, top and bottom temperatures were desired to be kept constant at 80° C. and 30° C. respectively. To find the evaporation and radiation losses Table 1 was employed for 80° C. and these losses came out to be 5034.7 and 788.9 (W/m²) respectively. Note that evaporation losses dominate and convection losses have been ignored. The experiment started at 10:10 AM on Jul. 5, 2015 with 24 heliostats without operating the pump. Once thermocouples in the first layer of mesh shown in FIG. 4G (i.e. M13, M14 and M15) reached 80° C., the pump started to operate. Table 2 shows the relation between DNI, incident flux and flow rate.

TABLE 2
Calculations for flow rate measurements

| Local Time | | | | | Number | | |
|---|---|---|---|---|---|---|---|
| in Abu Dhabi | | | | | of | Inlet flux | |
| on | Ideal inlet | DNI | HS | CR | working | on tank | Flow rate |
| 2015 Jul. 5 | flux (W) | (W/m²) | reflectivity | reflectivity | heliostats | (W) | (kg/min) |
| 7:00 | 2.85E+04 | 342.946705 | 0.8175 | 0.95 | 24 | 5511 | −0.0065087 |
| 8:00 | 4.39E+04 | 512.12779 | 0.8175 | 0.95 | 24 | 12687 | 2.05294655 |
| 9:00 | 5.09E+04 | 590.702062 | 0.8175 | 0.95 | 24 | 16997 | 3.28997553 |
| 10:00 | 6.42E+04 | 661.1675 | 0.8175 | 0.95 | 24 | 23988 | 5.29647047 |
| 11:00 | 7.77E+04 | 670.592442 | 0.8175 | 0.95 | 24 | 29412 | 6.85338947 |
| 12:00 | 8.28E+04 | 675.085528 | 0.8175 | 0.95 | 24 | 31572 | 7.4731191 |
| 13:00 | 7.72E+04 | 657.291295 | 0.8175 | 0.95 | 24 | 28644 | 6.63288451 |
| 14:00 | 6.41E+04 | 632.506425 | 0.8175 | 0.95 | 24 | 22907 | 4.98612471 |
| 15:00 | 5.05E+04 | 553.894745 | 0.8175 | 0.95 | 24 | 15794 | 2.94478671 |
| 16:00 | 4.34E+04 | 422.91534 | 0.8175 | 0.95 | 24 | 10368 | 1.38750752 |
| 17:00 | 2.77E+04 | 235.314718 | 0.8175 | 0.95 | 24 | 3683 | −0.5312679 |

The relation between flow rate, DNI and temperature on top layer of the mesh can be observed in FIG. 5(g) and FIG. 5(h). The maximum flow rate is 7.4 l/m but as can be seen in FIG. 5(h) during the experiment the flow rate was not raised above 6.2 l/min in order to maintain the top surface temperature of the mesh at 80° C. As already mentioned, after upper layer TCs in the mesh showed 80° C. (FIG. 5(h)), the pump started to operate at 11:20 AM. Over the next 15 minutes, the flow rate was kept at 5.6l/min and decreased to about 5.1l/min at 11:38 AM. However, the flow rate was again increased at around 12:00 PM as the calculation gave the value of 6.1 l/min for the corresponding DNI for that time period and it was not changed till 1:00 PM. Following this, the flow rate was reduced progressively until 3:00 PM by following the results obtained from calculation. The DNI decreased gradually from 3:00 PM and onwards (FIG. 5(g)), and consequently the temperature on top layer of mesh also dropped (FIG. 5(h)). Therefore, the flow rate was altered accordingly with the purpose of keeping the temperature as close as possible to 80° C. Finally, after noticing continuing gradual decrease in temperature at top layers of mesh, the pump was stopped at 16:20.

Temperature evolutions observed at different heights during the experiment are shown in FIG. 5(i). Thermocouples TC1,7,13,19; TC2,8,14,20; TC3,9,15,21; TC4,10,16,22; TC5,23 and TC6,24 are located at heights of 10.5; 44.5; 64; 83.5; 103 and 122.5 cm respectively (FIG. 3(c)). The water temperature at 122.5 cm increased sharply at 10:10 AM as HSs started to operate at that time. Once the temperature reached 80° C., the pump started to operate, shown with vertical red line at 11:40 AM in FIG. 5(i). Subsequently, the water temperature at 103 cm started to increase significantly while it had been rising slowly before the pump operation. Similarly, the rest of the water tank's temperatures rose to about at 77° C. by 15:00 (FIG. 5I) except TC_1,7,13,19 and TC_2,8,14,20. But, at 15:00, all temperatures started to decrease slowly as DNI decreased.

FIGS. 5(j) and 5(k) illustrate temperature distribution inside the mesh. It is apparent from the graph that water temperatures at the first and second layers of the mesh are rising sharply starting from the beginning of the experiment (10:10 AM) while the temperatures of the lower layers of the mesh are rising slowly before the pump starts. This is because most of the flux is absorbed by the upper layers. Once the pump starts operating, the temperatures of the lower layers rise fast as the warmer water from the top layers is being pushed to the lower layers. Later on, as DNI starts to drop, water temperature was also dropping and hence it was necessary to stop the pump at 16:20.

As can be seen from FIG. 5(g), the flow rate did not vary much between 13:15 and 14:30. Therefore, the average flow rate, 5.36 l/min was taken in that period. Additionally, plotting of the thermocline evolution from the experiment was started at 13:15 because thermocline started to evolve almost at that time. From FIG. 5(l) it seems that T=78° C. at bottom of mesh by 12:50 or even 12:43. In this graph, it also seen that the temperature at this height of 1.03 m was quite constant (a red rectangular box indicates the time range for considering thermocline evolution). As can be seen from the FIG. 5(m), the thermocline profile starts at the elevation of thermocouples of TC4 and TC22, which corresponds to a height of 83.5 cm. Hence, this height was taken to calculate theoretical thermocline evolution.

It is seen from the FIG. 5(m) that the slope of the thermocline is becoming greater with time but from the thermodynamic points of view it is not possible. The reason for the plot to behave in this way is that there are not sufficient thermocouple points to measure the temperature between the height of 0.4 and 0.8 m. Thus, excel is using its algorithm to change the shape of the line which is not desirable in this case.

FIG. 5(m) illustrates thermocline evolution from the experiment while FIG. 2(g) shows theoretical thermocline evolution. From these graphs it is obvious that there is a variance between them. The experiment shows that the thermocline extends to around 0.4 m but calculation indicates it should reach 0.3 m. Also, thermocline thickness is 0.435 m in the experiment whereas in the semi-infinite model it is almost 0.36 m after 75 minutes from start of thermocline development. Following this, according to the model, the temperature at the bottom of the tank should remain at 30° C. during this time period (FIG. 2(g)). However, during the experiment the temperature at the bottom of the tank is rising slightly, by around 3K (FIG. 5(m)).

The observed differences between calculation and experiment could be explained by the following reasons. First, in the calculation, the top of the tank is assumed to be at 80° C. and the rest to be at 30° C. But during the actual thermocline evolution in the experiment this was not the case, as the rest of the tank was already influenced and was at high temperature. Furthermore, the observed thermocline has finite thickness at time zero (at 1:15 PM) during the experiment but it has zero thickness initial condition in the theoretical model. There are several factors which caused the temperature to increase at the bottom of water tank during the experiment. But, before explaining these factors, it is important to understand how the apparatus for the experiment was installed and how the whole process was operated. There are few elements that need to be understood about the experiment. Starting with a submersible pump which had very high flow rate (13 l/min) for our purpose (7 l/min). Also, several alterations were done to decrease this flow rate which is seen in FIG. 5(f).

Another element which must be mentioned is that the water level was kept at constant height which was 10 cm higher than mesh by putting the hose which has one end connected to the water tap and the other one fixed at the bottom of the tank shown in FIG. 5l.

From the above mentioned conditions, temperature increased at the bottom of the tank could be explained. Make up and feed water was heated up as it was coming from the top of the water tank to bottom and because the top side of water tank was obviously hot (at around 80° C.), heat could transfer to feeding water in the hose. In future a perforated vertical diffuser tube, should be used.

The purpose of establishing plug flow within the tank is to help ensure that the temperature on any horizontal cross section of the water tank will be uniform. To show that plug flow was achieved it is thus necessary (but not sufficient) that thermocouples at the same level exhibit almost the same temperature. Therefore, the sets of thermocouples that should show temperature uniformity are TC 1,7,13,19; TC2,8,14,20; TC3,9,15,21; TC4,10,16,22; TC5,23; and TC6,24. Experimental evaluation of these sets of thermocouples successfully demonstrated temperature uniformity in FIG. 5O, consistent with the establishment of plug flow. FIG. 5O shows in detail the temperature distribution in the tank plotted against time. For instance, TC6 and TC24 both recorded temperatures close to 45° C. at 10:30 AM. Similarly, at 11:20 AM TC5 and TC23 both recorded temperatures close to 40° C. Interestingly, the temperature at TC5,23 shows a sudden, but mild increase when the pump started to operate and at the same time a drop in temperature could be observed at TC6,24. However, TC2,8,14,20 show little change in temperature since TC 8,20 showed much higher temperatures than TC2 and TC14. This might be due to the fact that the hose of feed water was placed close to TC 2 and hence its temperature is lesser than the others (FIG. 5O).

FIG. 5(p) illustrates temperatures recorded by each TC in the volumetric mesh absorber. A red line indicates the starting time of the pump, at which time the temperature starts decreasing at the top layer of the mesh after rising sharply before the pump was started. The main intent of FIG. 5P is to show how the temperatures inside the mesh were nearly equal within each layer even as they evolved in time. Temperatures inside the mesh at the same level were quite close to each other and only TCM_6 &TCM_3 were rising a little slowly compared to the other TCs at same level. Also, TCM_7, 8,9 was rising almost at the same rate. These results demonstrated that the plug flow injection system was working very well during the experiment.

An alternative concept to a divider-plate thermocline TES is also investigated with the purpose of evaluating natural thermocline thickness to the divider plate. The thermocline concept has been evaluated theoretically using both molten salt and water properties and experimentally using water as HTF. The experiment was done under the BDOE at Masdar Institute, Abu Dhabi. For the TES experiment a downward plug flow was achieved using a variable speed pump to circulate water from the bottom of the tank (1.5 m diameter×1.4 m height tank) to a distribution ring at the top of the tank.

The successful implementation of a plug flow injection system helped to maintain natural stratification within the tank. Development of natural stratification and plug flow assisted in moving the thermocline interface from the top of the tank to almost bottom of the tank. At the same time, volumetric mesh absorber at the top of the tank heated the entering HTF to 80° C. such that the upper hot zones within the tank could propagate downward pushing, without disrupting, the cold zones ahead of it. The mesh at the top functions as the receiver and the region below the mesh, where most of the salt mass resides, functions as thermal energy storage.

Thermocline evolution was modelled analytically using the concept of two semi-infinite solid bodies in contact. Results show that during charging of the molten salt tank the thermocline thickness increased 0.14 m after 2 hours to 0.22 m after 5 hours. While during discharging of the molten salt tank with mass flow rate of half the charging mass flow rate the thickness was also 0.14 and 0.22 m after 2 and 5 hours respectively. Thermocline thickness during the experiment ranged between 0.3 m (at 13:30) and 0.35 m (at 14:30), an increase of 0.05 m in one hour. Therefore, using natural stratification concept instead of a divider plate in the TES could be a reasonable alternative if it improves a plant's net present value.

In another embodiment, lower surface temperatures can be achieved by a more transparent but less porous absorber. In another embodiment, a standalone cool-surface mesh receiver directly irradiated from above (not integrated with TES) is possible and useful. In another embodiment, a standalone cool-surface mesh receiver directly irradiated from below using quartz window is possible and useful.

Many changes, modifications, variations and other uses and applications of the subject invention will become apparent to those skilled in the art after considering this specification and the accompanying drawings, which disclose the preferred embodiments thereof. All such changes, modifications, variations and other uses and applications, which do not depart from the spirit and scope of the invention, are deemed to be covered by the invention, which is to be limited only by the claims which follo

[symbol]

1.-20. (canceled)

21. A thermal energy receiving and storage system for concentrated solar power plants comprising:
a tank for receiving a heat transfer fluid, wherein the tank includes a bottom portion and a top portion and wherein the bottom portion includes a basis and wherein the top portion includes an opening;
an absorbing mesh mountable within the tank for establishing and maintaining thermal stratification resulting in a thermocline zone within the tank; and
a plug flow injection system for establishing plug flow within the tank.

22. The system of claim 21, wherein the absorbing mesh is located at the top portion of the tank in proximity of the opening.

23. The system of claim 22, wherein the absorbing mesh is configured for directing the thermocline zone down towards the bottom portion of the tank.

24. The system of claim 21, wherein the absorbing mesh is a woven wire mesh made of black anodized stainless steel.

25. The system of claim 21, wherein the absorbing mesh comprises multiple layers deployed along a vertical axis of the tank between the basis and the opening of the tank.

26. The system of claim 25, wherein the absorbing mesh has between 5 and 15 layers.

27. The system of claim 21, wherein the plug flow injection system includes a pump for pumping cold heat transfer fluid from the bottom portion of the tank to the top portion of the tank above the absorbing mesh.

28. The system of claim 27, wherein the plug flow injection system include one or more hoses extending within the tank, and wherein the hoses include openings, and wherein the cold heat transfer fluid from the bottom portion of the tank is directed out of the openings in the hoses and across the top portion of the tank.

29. The system of claim 28, wherein the one or more hoses include a cylindrical hose positioned intermediate the opening in the tank and the absorbing mesh, and wherein the cylindrical hose defines a circle having a central axis, and wherein the cylindrical hose includes openings for directing cold heat transfer fluid inwardly in the direction of the central axis to establish plug flow within the tank.

30. The system of claim 21, wherein the tank includes a vertical axis extending between the bottom portion and the top portion and wherein the tank includes a plurality of horizontal cross-sections, each horizontal cross-section extending perpendicular to the vertical axis between the bottom basis and the opening, and wherein the heat transfer fluid has a uniform temperature uniform across each horizontal cross-section when plug flow is established within the tank.

31. The system of claim 21, wherein the thermal stratification and the plug flow assist in moving the thermocline zone from the top portion of the tank in proximity of the opening to the bottom portion of the tank in proximity of the basis.

32. The system of claim 21, wherein the system is devoid of divider plates.

33. The system of claim 21, wherein thermal stratification resulting in the thermocline zone is achieved without using divider plates.

34. A method of establishing and maintaining thermal stratification within a concentrated solar power plant heat transfer fluid storage tank, the method comprising:
providing a thermal energy receiving and storage system for concentrated solar power plants according to claim 21, wherein the absorbing mesh is positioned in the top portion of the tank in the proximity of the opening;
directing cold heat transfer fluid from the bottom portion of the tank to the top portion of the tank, wherein directing the cold heat transfer fluid into the top portion of the tank includes injecting the cold heat transfer fluid into a defined area of the tank; and
controlling the amount of cold heat transfer fluid that is injected into the defined area to establish and maintain a plug flow of heat transfer fluid and a thermocline zone in the tank, thereby establishing and maintaining thermal stratification within the tank.

35. The method of claim 34, wherein the absorbing mesh moves the thermocline zone toward the bottom portion of the tank.

36. The method of claim 34, wherein the absorbing mesh is a woven wire mesh made of black anodized stainless steel.

37. The method of claim 34, wherein the absorbing mesh includes multiple layers deployed along a vertical axis of the tank between the basis and the opening of the tank.

38. The method of claim 34, wherein the defined area includes a circular area having a central axis intermediate the tank opening and the absorbing mesh, and wherein injecting the cold heat transfer fluid into the defined area includes directing the cold heat transfer fluid towards the central axis of the circular area.

39. The method of claim 34, wherein the tank has a vertical axis between the bottom portion and the top portion and horizontal cross-sections extending perpendicular to the vertical axis between the bottom basis and the opening, and wherein the heat transfer fluid has a uniform temperature across each horizontal cross-section after the plug flow is established.

40. The method of claim 34, wherein the thermal stratification and the plug flow assist in moving the thermocline zone from the top portion of the tank in proximity of the opening to the bottom portion of the tank in proximity of the basis.
